(19) United States
(12) Patent Application Publication
(10) Pub. No.: US 2026/0322724 A1
(43) Pub. Date: Oct. 15, 2026

(54) Congestion Management in Satellite-Based Communications Networks

(71) Applicant: Apple Inc., Cupertino, CA (US)

(72) Inventors: Shahram Talakoub, San Jose, CA (US); Sebastian B Seeber, San Carlos, CA (US); Travis J Robson, Mountain View, CA (US); Saurabh Deo, Cupertino, CA (US); Michael E Adams, San Diego, CA (US); Adam J Moore, San Francisco, CA (US); Ashley M Williams, Mountain View, CA (US); Gregory R Nelson, Los Altos, CA (US); Sudeep Bhattarai, Fremont, CA (US)

(21) Appl. No.: 19/174,603

(22) Filed: Apr. 9, 2025

(51) Int. Cl. H04L 43/0882; H04L 5/00; H04L 43/10; H04W 60/04; H04W 84/06

(52) U.S. Cl. CPC H04L 43/0882; H04L 5/0053; H04L 43/10; H04W 60/04; H04W 84/06

(57) ABSTRACT

A communications system may include a core network (CN) that communicates with a user equipment (UE) device via a satellite constellation. While a congestion level of a serving satellite in the constellation exceeds a threshold and an uplink message queue is empty, the UE may transmit heartbeat signals with a heartbeat period to signal to the CN that the UE device is still active in its communications session. Receipt of a reverse link signal such as the heartbeat may trigger the CN to reset a timer. When the CN receives a forward link message for the UE device, the CN may place the message into a queue. The CN may increase a priority of the queued message when less than the heartbeat period has elapsed and may decrease priority of the queued message when longer than the heartbeat period has elapsed since the timer was reset.

### FIELD

This relates generally to wireless communications, including wireless communications by electronic devices.

### BACKGROUND

Communications systems are used to convey data between terminals such as user equipment (UE) devices. Some communications systems include satellites that wirelessly convey data between user equipment devices and gateways. It can be challenging to ensure that these types of communications systems are able to exhibit satisfactory performance across a wide range of operating conditions, such as when the satellites are subject to high levels of network congestion.

### SUMMARY

A communications system may include a core network (CN) that communicates with a set of user equipment (UE) devices via a constellation of satellites and one or more gateways. A UE device may register with the CN via the constellation to establish a corresponding communications session with the CN. The CN may transmit broadcast messages to the UE device via a serving satellite in the constellation. The broadcast messages may identify a congestion level of the serving satellite.

The UE device may utilize the current congestion level of the serving satellite to perform or backoff reverse link (RWD) message transmission to the CN. When the congestion level exceeds a threshold, the UE device may begin a heartbeat timer. While the congestion level exceeds the threshold and an uplink message queue of the UE device is empty, the UE may transmit a heartbeat signal after the heartbeat timer elapses. The UE may continue to periodically transmit the heartbeat signal each time the heartbeat timer elapses (e.g., with a corresponding heartbeat period) while the congestion level remains above the threshold and the uplink message queue remains empty. Transmission of a RWD message from the uplink message queue may restart the heartbeat timer. The heartbeat signals may signal to the core network that the UE device is still active and able to receive forward link (FWD) messages before a predetermined duration of the communications session has elapsed.

The CN may receive a RWD signal from the UE device via the serving satellite while the congestion level exceeds the threshold. The RWD signal may include a RWD message or a heartbeat signal. Receipt of the RWD signal may trigger the CN to reset a timer and a counter. When the CN receives a FWD message destined for the UE device, the CN may place the FWD message into a FWD message queue. The CN may increase or maintain a priority level of the FWD message in the FWD message queue when shorter than the heartbeat period has elapsed since the timer was reset. On the other hand, the CN may decrease or maintain a priority level of the FWD message in the FWD message queue when longer than the heartbeat period of the heartbeat signals has elapsed. The CN may attempt to transmit the FWD message from the FWD message queue (e.g., according to its updated priority) to the UE device via its serving satellite. The CN may increment the counter with each attempted transmission. When the counter exceeds a threshold value, the CN may remove the FWD message from the FWD message queue.

An aspect of the disclosure provides a method of operating a user equipment (UE) device to communicate with a core network via a constellation of satellites. The method can include entering, using a radio, a communications session by registering with the core network via the constellation. The method can include receiving, using the radio during the communications session, a congestion level of the constellation. The method can include periodically transmitting, using the radio during the communications session, heartbeat signals to the core network via the constellation while the congestion level exceeds a threshold and while a reverse link message queue of the radio is empty.

An aspect of the disclosure provides a method of operating a core network to communicate with a first user equipment (UE) device and a second UE device via a serving satellite of a constellation. The method can include receiving, from the first UE device via the serving satellite in a first communications session, a first reverse link (RWD) message at a first time. The method can include receiving, from the second UE device via the serving satellite in a second communications session, a second RWD message at a second time after the first time. The method can include receiving, from the second UE device via the serving satellite in the second communications session, a series of periodic heartbeat signals after the second time, wherein the core network does not receive signals from the first UE device between the second time and an end of the first communications session. The method can include receiving, from a first terminal at a third time after the second time and during the first communications session, a first forward link (FWD) message destined for the first UE device. The method can include receiving, from a second terminal at a fourth time after the third time and during the second communications session, a second FWD message destined for the second UE device. The method can include transmitting, in the first communications session, the second FWD message to the second UE device via the serving satellite prior to transmitting the first FWD message to the first UE device.

An aspect of the disclosure provides a method of operating a core network to communicate with a user equipment (UE) device via a satellite in a constellation. The method can include receiving, from the UE device via the satellite, a reverse link (RWD) signal while a congestion level of the satellite exceeds a threshold. The method can include resetting, using processing circuitry, a timer in response to receipt of the RWD signal. The method can include receiving a forward link (FWD) message for the UE device and storing the FWD message in a transmission queue. The method can include increasing, using the processing circuitry, a priority of the FWD message in the transmission queue in response to the FWD message being received less than a predetermined time period since the timer was reset. The method can include attempting to transmit the FWD message to the UE device via the satellite according to the transmission queue.

### BRIEF DESCRIPTION OF THE DRAWINGS

FIG. 1 is a diagram of an illustrative communications system including user equipment devices that communicate with a core network via a constellation of communications satellites in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a schematic diagram of an illustrative core network in accordance with some embodiments.

FIG. 5 is a flow chart of illustrative operations involved in performing reverse link transmissions using a user equipment device in accordance with some embodiments.

FIG. 6 is a table of illustrative weight factors that may be used by a user equipment device to perform reverse link transmissions in accordance with some embodiments.

FIG. 7 is a table of illustrative congestion policies that may be imposed by a core network on traffic associated with user equipment services of different priority levels in accordance with some embodiments.

FIG. 8 is a flow chart of illustrative operations involved in transmitting periodic heartbeat signals from a user equipment device to a core network in accordance with some embodiments.

FIG. 9 is a flow chart of illustrative operations that may be performed by a core network to schedule and prioritize forward link transmissions for a user equipment device in accordance with some embodiments.

FIG. 10 is a flow chart of illustrative operations that may be performed by a user equipment device to transmit periodic heartbeat signals to a core network in accordance with some embodiments.

FIG. 11 is a timing diagram showing how different protocol layers of an illustrative user equipment device may generate and transmit a periodic heartbeat signal in accordance with some embodiments.

FIG. 12 is an illustrative timing diagram showing how periodic heartbeat signals may configure a core network to prioritize forward link transmissions for a corresponding user equipment device in accordance with some embodiments.

### DETAILED DESCRIPTION

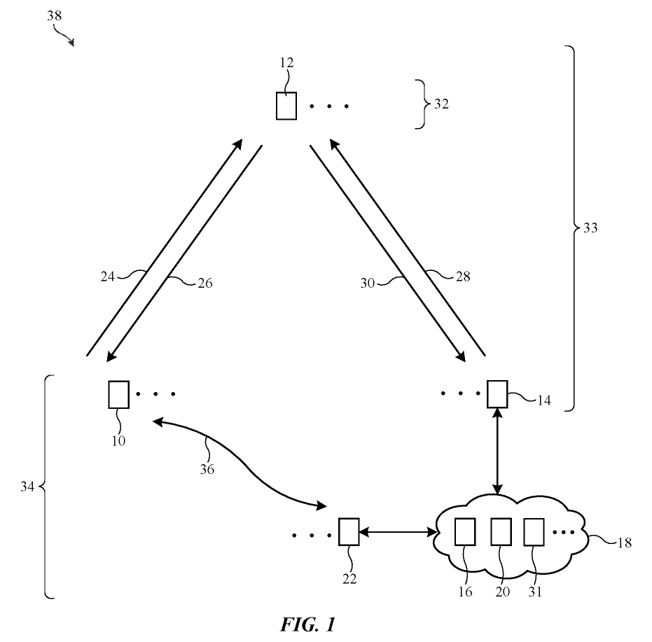

FIG. 1 is a diagram of an illustrative communications system 38. Communications system 38 may include a ground-based (terrestrial) gateway system that includes one or more gateways 14. Communications system 38 may also include one or more user equipment (UE) devices 10. Gateways 14 and UE devices 10 may form a part of a terrestrial network 34 on Earth. Terrestrial network 34 may include terrestrial-based wireless communications equipment 22 and network portion 18. Terrestrial-based wireless communications equipment 22 may include, for example, one or more wireless base stations (e.g., gNBs for implementing a cellular telephone network), wireless access points (e.g., for implementing a wireless local area network (WLAN)), and/or other UE devices (e.g., for implementing a device-to-device (D2D) network, a wireless personal area network (WPAN), etc.).

Communications system 38 may include a constellation 32 of one or more communications satellites 12. UE devices 10, gateways 14, and constellation 32 may form a part of non-terrestrial network (NTN) 33 that conveys signals between UE devices 10 and gateways 14 via constellation 32. Constellation 32 is sometimes also referred to herein as satellite constellation 32. Communications satellites 12 are sometimes also referred to herein simply as satellites 12. Satellites 12 are located in space (e.g., in orbit around Earth). Communications system 38 may include any desired number of gateways 14, any desired number of satellites 12, and any desired number of UE devices 10. Only a single gateway 14, a single satellite 12, and a single UE device 10 are illustrated in FIG. 1 for the sake of simplicity. Each gateway 14 in communications system 38 may be located at a different respective geographic location on Earth (e.g., across different regions, cities, counties, prefectures, districts, municipalities, land masses, areas, localities, states, provinces, countries, continents, etc.). Communications system 38 is sometimes also referred to herein as communications network 38, network 38, system 38, satellite communications system 38, satellite-based communications system 38, satellite-based communications network 38, or satellite communications network 38.

Network portion 18 (sometimes also referred to herein simply as network 18) may be communicatively coupled to terrestrial-based wireless communications equipment 22 and each of the gateways 14 in communications system 38. Gateway (GW) 14 may include a satellite network ground station and is therefore sometimes also referred to as ground station (GS) 14 or satellite network ground station 14. Each gateway 14 may include one or more electronic devices (e.g., servers, network racks, desktop computers, laptop computers, other network devices, etc.) that interface between constellation 32 and network portion 18. Each gateway 14 may also include wireless equipment communicatively coupled to the device(s). The wireless equipment may include antennas (e.g., electronically and/or mechanically adjustable antennas), modems, transceivers, amplifiers, beam forming circuitry, software defined radios, hardware radios, control circuitry (e.g., one or more processors, storage circuitry, etc.), and other components that are used to convey communications data. The devices and components of a given gateway 14 may, for example, be disposed at a corresponding geographic location (e.g., within the same computer, server, data center, building, etc.). Gateways 14 may convey communications data between terrestrial network 34 and UE devices 10 via constellation 32 (e.g., gateways 14 may serve as an interface between NTN 33 and terrestrial network 34).

Network portion 18 may include any desired number of network nodes (e.g., terminals, devices, end hosts, etc.) that are communicatively coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with constellation 32 and/or may control the operation of the satellites in constellation 32. For example, NOC 16 may generate and transmit control commands via gateways 14 that control positioning operations (e.g., orbit adjustments, rotations, etc.), payload deployment operations, sensing operations (e.g., thermal information gathered using one or more thermal sensors), and/or any other desired operations performed in space by satellites 12. NOC 16, gateways 14, and constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via constellation 32. The satcom network service provider may be a different entity than the satellite constellation operator that controls/operates NOC 16, gateways 14, and constellation 32, or may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of constellation 32 over corresponding radio-frequency communications links. Constellation 32 may include any desired number of satellites (e.g., two satellites, four satellites, ten satellites, dozens of satellites, hundreds of satellites, thousands of satellites, etc.), one of which is shown in FIG. 1. If desired, two or more of the satellites in constellation 32 may convey radio-frequency signals between each other using satellite-to-satellite (e.g., relay) links.

Constellation 32 may include a set of non-geostationary orbit (NGSO) satellites 12 (e.g., satellites in non-geostationary orbits) and, if desired, may include a set of geostationary orbit (GSO) satellites 12 (e.g., satellites in geostationary/geosynchronous orbits, sometimes referred to as geosynchronous satellites or GEO satellites). GSO satellites in constellation 32 may orbit Earth at orbital altitudes of greater than around 30,000 km. NGSO satellites in constellation 32 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellites in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit, orbital plane, and/or orbital altitude. In general, constellation 32 may include satellites in any desired combination of orbits or orbit types.

The satellites 12 in constellation 32 may communicate with one or more UE devices 10 on Earth using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between UE devices 10 and satellites 12 and between satellites 12 and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications (satcom) bands. If desired, different bands may be used for the satellite-to-user equipment links than for the satellite-to-gateway links.

Communications may be performed between gateways 14 and UE devices 10 in a forward link (FWD) direction and/or in a reverse link (REV or RWD) direction. In the FWD direction (sometimes referred to simply as the forward link), wireless data is conveyed from gateway(s) 14 to UE device(s) 10 via constellation 32. Wireless data conveyed over the forward link is sometimes referred to herein as forward link data or FWD data. The FWD data may include one or more FWD messages organized into a set, series, or stream of one or more FWD datagrams (e.g., where each FWD datagram has one or more header fields that contain header information with a destination address identifying a corresponding UE device, a payload field that contains a forward link data payload, etc.). Gateways 14 may receive FWD messages for transmission to UE devices 10 from network portion 18.

A gateway 14 may, for example, transmit radio-frequency signals 28 to constellation 32. Gateway 14 may transmit FWD data (e.g., in one or more FWD messages) by modulating one or more FWD datagrams onto one or more carriers of radio-frequency signals 28. Satellite 12 may transmit (e.g., forward or relay, in a bent-pipe configuration) the incident FWD data to UE device(s) 10 using radio-frequency signals 26 (e.g., without decoding or demodulating the FWD data between receiving the FWD data in radio-frequency signals 28 and transmitting the FWD data in radio-frequency signals 26). Radio-frequency signals 28 are conveyed in an uplink direction from gateway 14 to satellite 12 and are therefore sometimes also referred to herein as uplink (UL) signals 28, forward link UL signals 28, forward link signals 28, or FWD signals 28. Radio-frequency signals 26 are conveyed in a downlink direction from satellite 12 to UE device(s) 10 and are therefore sometimes also referred to herein as downlink (DL) signals 26, forward link DL signals 26, forward link signals 26, or FWD signals 26. Forward link signals conveyed from gateways 14 to UE devices 10 via constellation 32 may include forward link data, control signals, broadcast messages, and/or other types of FWD signals and/or waveforms.

In the reverse link direction (sometimes referred to simply as the reverse link), wireless data is conveyed from UE device(s) 10 to gateway(s) 14 via constellation 32. Wireless data conveyed over the reverse link is sometimes referred to herein as reverse link data, RWD data, or REV data. The RWD data may include one or more RWD messages organized into a set, series, or stream of one or more RWD datagrams (e.g., where each RWD datagram has one or more header fields that contain header information with a destination address identifying a corresponding destination terminal, a payload field that contains a reverse link data payload, etc.).

A UE device 10 may, for example, transmit radio-frequency signals 24 to one of the satellites 12 in constellation 32. UE device 10 may transmit RWD data (e.g., one or more RWD messages) by modulating one or more RWD datagrams onto one or more carriers of radio-frequency signals 24. Satellite 12 may transmit (e.g., forward or relay, in a bent-pipe configuration) the incident RWD data to gateway(s) 14 using radio-frequency signals 30 (e.g., without decoding or demodulating the RWD data between receiving the RWD data in radio-frequency signals 24 and transmitting the RWD data in radio-frequency signals 30). Radio-frequency signals 24 are conveyed in an uplink direction from UE device 10 to satellite 12 and are therefore sometimes also referred to herein as uplink (UL) signals 24, reverse link UL signals 24, reverse link signals 24, or RWD signals 24. Radio-frequency signals 30 are conveyed in a downlink direction from satellite 12 to gateway(s) 14 and are therefore sometimes also referred to herein as downlink (DL) signals 30, reverse link DL signals 30, reverse link signals 30, or RWD signals 30. Reverse link signals conveyed from UE devices 10 to gateways 14 via constellation 32 may include reverse link data and/or other types of RWD signals and/or waveforms. Gateway 14 may forward incident RWD data to network portion 18. Network portion 18 may forward the RWD data to any desired network nodes or terminals of terrestrial network 34.

If desired, UE devices 10 may also convey radio-frequency signals with terrestrial-based wireless communications equipment 22 over one or more terrestrial network wireless communication links 36 when available. A UE device 10 is sometimes referred to herein as being “online” or “on-grid” when the UE device is within range of terrestrial-based wireless communications equipment 22 and when terrestrial-based wireless communications equipment 22 provides access (e.g., communications resources) to network portion 18 for the UE device. When the UE device is on-grid, the UE device may communicate with other network nodes or terminals in network portion 18 via terrestrial network wireless communications links 36. Conversely, a UE device 10 is sometimes referred to herein as being “offline” or “off-grid” when the UE device is out of range of terrestrial-based wireless communications equipment 22 or when terrestrial-based wireless communications equipment 22 does not provide access to network portion 18 for the UE device (e.g., when terrestrial-based wireless communications equipment 22 is disabled due to a power outage, natural disaster, traffic surge, or emergency, when terrestrial-based wireless communications equipment 22 denies access to network portion 18 for the UE devices, when terrestrial-based wireless communications equipment 22 is overloaded with traffic, etc.). When the UE device is off-grid, the UE device is unable to communicate with other network nodes or terminals in network portion 18 via terrestrial network wireless communications links 36.

If desired, UE device 10 may include separate antennas for handling communications over the satellite-to-user equipment link and one or more terrestrial network wireless communication links 36. Alternatively, UE device 10 may include a single antenna that handles both the satellite-to-user equipment link and the terrestrial network wireless communications links. The terrestrial network wireless communications links may include, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, etc.), wireless local area network links (e.g., Wi-Fi® links), wireless personal area network links (e.g., Bluetooth links), D2D links, etc.

Baseband and/or radio-frequency circuitry on UE devices 10 generate RWD data for transmission to gateways 14. On the other hand, FWD data may be generated by any desired network nodes or terminals of terrestrial network 34. The FWD data and the RWD data may include text data such as email messages, text messages, web browser data, an emergency or SOS message, a location message identifying the location of UE device(s) 10, a location message identifying the location of other devices, and/or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10 (e.g., application data), data for use in a distributed processing network (e.g., a cloud computing network), and/or any other desired data. UE devices 10 may only receive FWD data, may only transmit RWD data, or may both transmit RWD data and receive FWD data. Each satellite 12 exhibits a corresponding wireless coverage area. Each satellite 12 may communicate with the UE devices 10 located within its coverage area at any given time (e.g., UE devices 10 located within cells on Earth that overlap the signal beam(s) producible by the satellite).

The satcom network service provider for communications system 38 may operate, control, and/or manage a satcom control network such as core network (CN) 20 in network portion 18. CN 20 is sometimes also referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to as a CN cloud region or satcom network cloud region.

CN 20 may control and coordinate wireless communications between terminals (e.g., end hosts) of terrestrial network 34 and UE devices 10 via constellation 32. For example, gateways 14 may receive RWD data (e.g., one or more RWD messages) from UE devices 10 via constellation 32 and may route the RWD data to CN 20. CN 20 may perform any desired processing operations on the RWD data. For example, CN 20 may identify destinations for the RWD data (e.g., from destination addresses in header fields of the RWD datagrams carrying/representing the RWD data) and may forward the RWD data to the identified destinations. CN 20 may also receive FWD data for transmission to UE devices 10 from one or more terminals or end hosts of terrestrial network 34 (e.g., network portion 18). CN 20 may process the FWD data to schedule the FWD data for transmission to UE devices 10 via constellation 32. CN 20 may schedule the FWD data for transmission to UE devices 10 by generating forward link traffic grants for each of the UE devices that are to receive FWD data. CN 20 may provide the FWD data (e.g., one or more FWD messages) and the forward link traffic grants to gateways 14. Gateways 14 may transmit the FWD data to UE devices 10 via constellation 32 according to the forward link traffic grants (e.g., according to a forward link communications schedule that implements the forward link traffic grants).

Network portion 18 may include one or more networks 31 that provide wireless data and/or services to UE device 10. Network 31 may include one or more servers. Network 31 may include, for example, a content delivery network (CDN) that provides content to CN 20 for delivery to UE device 10 (e.g., via terrestrial-based wireless communications equipment 22 while UE device 10 is on-grid or in FWD data routed via constellation 32 while UE device 10 is off-grid). If desired, network 31 may receive wireless data from UE device 10 via CN 20 (e.g., via terrestrial-based wireless communications equipment 22 while UE device 10 is on-grid or in RWD data routed via constellation 32 while UE device 10 is off-grid). Network 31 may be the intended recipient of the wireless data or may forward the wireless data to an intended recipient (e.g., another server or network, another UE device, etc.). If desired, network 31 may include a network associated with one or more software applications running on UE device 10.

The time resources used for satellite-based communications between CN 20 and a UE device 10 may be divided into a series of repeating system cycles over time (sometimes also referred to as system frames or communications cycles). Each system cycle may include a respective FWD cycle (sometimes also referred to as a downlink cycle) and/or a respective RWD cycle (sometimes also referred to as an uplink cycle). During each FWD cycle, CN 20 may transmit a respective broadcast (BC) message (e.g., containing broadcast information) to all the UE devices 10 served by a given satellite 12 via that satellite 12 (e.g., in a broadcast interval (BCI) of the FWD cycle). The satellite 12 that communicates with a given UE device 10 is sometimes also referred to herein as the serving satellite 12 of that UE device 10. CN 20 may also transmit one or more unicast messages (e.g., FWD messages containing FWD data) to one or more of the UE devices 10 served by the serving satellite during the FWD cycle (e.g., during a portion of the FWD cycle not occupied by the broadcast interval). During a RWD cycle, a UE device 10 may transmit a RWD message (e.g., containing RWD data) to CN 20 via its serving satellite 12. The RWD message may include, for example, one, two, or more than two RWD datagrams. The RWD cycle may have the same duration as the FWD cycle or may have a different duration. Each system cycle may have a duration (period) of between 2 seconds and 3 seconds (e.g., 2.56 seconds), between 1 second and 10 seconds, between 1 second and 5 seconds, greater than 1 second, greater than 2 seconds, less than 5 seconds, less than 10 seconds, or other durations. This is illustrative and, in general, the embodiments described herein may apply to any desired underlying satellite network technologies having any desired system cycles and having communications with any desired division of time and/or frequency resources. If desired, the constellation 32 of satellites 12 in any of the embodiments described herein may be replaced with an aerial constellation (e.g., where aerial vehicles or aircraft replace satellites 12) or a terrestrial-based network (e.g., where terrestrial nodes replace satellites 12).

UE device 10 may be a computing device such as a laptop computer, a desktop computer, a computer monitor (e.g., containing an embedded computer), a tablet computer, a cellular telephone, a media player, or another handheld or portable electronic device, a smaller device such as a wristwatch device, a pendant device, a headphone or earpiece device, a device embedded in eyeglasses or other equipment worn on a user’s head (e.g., a virtual, mixed, and/or augmented reality headset, glasses, goggles, or helmet), a ring device worn on a user’s finger, or another type of wearable or miniature device, a television, a computer display (e.g., that does not contain an embedded computer), a gaming device (e.g., a portable gaming system, a non-portable gaming system, etc.), a navigation device, an embedded system such as a system in which electronic equipment with a display is mounted in a kiosk, furniture, building, wall, an automobile, or another type of vehicle, a wireless internet-connected voice-controlled speaker, a home entertainment device, a remote control device, a gaming controller, a peripheral user input device, a wireless access point, equipment that implements the functionality of two or more of these devices, or other electronic equipment.

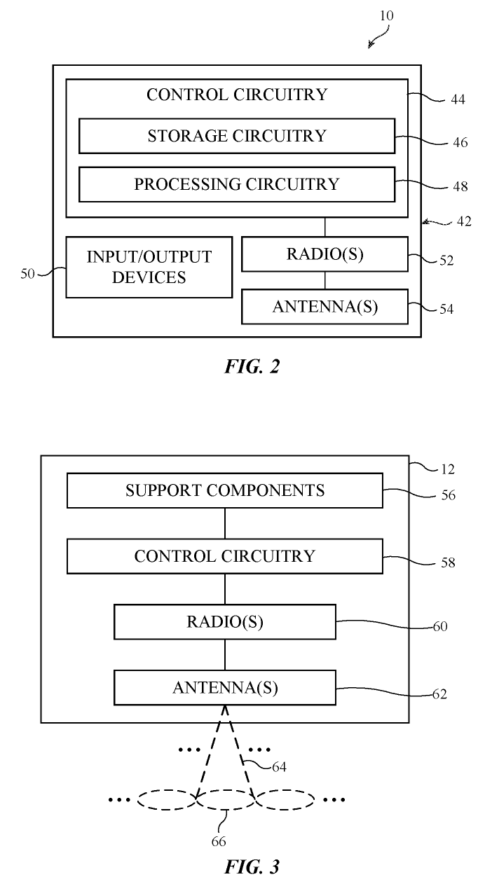

As shown in FIG. 2, UE device 10 may include components located on or within an electronic device housing such as housing 42. Housing 42, which is sometimes also referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, applications processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code is sometimes also referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, cloud computing applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols – sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in constellation 32 on storage circuitry 46. The satellite information, sometimes referred to herein as ephemeris data, ephemeris information, or satellite ephemeris, may include a satellite almanac identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include a two-line element (TLE), for example. The TLE may identify or include information about the orbital motion of one or more of the satellites 12 in constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris data to calculate, predict, or identify the location of satellites 12 at different points in time.

UE device 10 may also include wireless communications circuitry to support wireless communications. The wireless communications circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these implementations, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time. When receiving signals, the pointing direction of the signal beam corresponds to phase and magnitude settings that cause radio-frequency signals incident upon each of the antenna elements to coherently add together in the receive path of radio(s) 52.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be communicatively coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency transmission lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Although control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform functions at a physical (PHY) layer (e.g., Layer 1 of the Open Systems Interconnection (OSI) model), a data link layer (e.g., a medium access control (MAC) layer, a logical link control (LLC) layer, etc.), a radio link control (RLC) layer, a packet data convergence protocol (PDCP) layer, a service data adaptation protocol (SDAP) layer, a protocol data unit (PDU) layer, etc., and/or to perform control plane functions at the PHY layer, MAC layer, RLC layer, PDCP layer, radio resource control (RRC) layer, non-access stratum (NAS) layer, etc. Processing circuitry 48 may include an applications processor (AP) that executes one or more software applications and/or an operating system that accesses and operates on data at the application (APP) layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, which are generally mobile and able to move between different locations, gateway 14 is stationary and remains at a fixed location on Earth. Gateways 14 are not owned or operated by end users of UE devices 10. Gateway 14 may include one or more electronic devices such as one or more servers or terminals. The electronic device(s) of a gateway 14 may be enclosed within a housing, enclosure, building, etc.

FIG. 3 is a diagram of an illustrative satellite 12 in constellation 32. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam 64 in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams 64 if desired. If desired, satellite 12 may offload some or all of its beam forming operations to gateway 14 and/or CN 20. Signal beams 64 may sometimes be referred to herein simply as beams 64.

A phased array antenna in satellite 12 may have a set of formable signal beams 64 each oriented in a different beam pointing direction or angle (e.g., a direction or angle of peak signal gain). Each signal beam 64 may be formed using a different respective set of phase and magnitude settings for the antenna elements in the phased array antenna and/or using a different respective set of active antenna elements in the phased array antenna. Satellite 12 may transmit and/or receive radio-frequency signals within the active signal beam(s) 64 of the phased array antenna (e.g., satellite 12 may wirelessly serve UE devices 10 that overlap active signal beam(s) 64). Inactive signal beam(s) 64 do not convey radio-frequency signals. Active signal beams 64 are sometimes also referred to as illuminated, enabled, powered, or energized signal beams 64. Inactive signal beams 64 are sometimes also referred to as unilluminated, disabled, unpowered, or de-energized signal beams 64.

If desired, satellite 12 may switch between different active signal beams 64 over time according to a beam hopping scheme or schedule. The beam hopping scheme may identify a time schedule for the activation of different signal beams 64 for each system cycle of satellite 12 (e.g., such that each signal beam is active at least once during each system cycle). If desired, gateway(s) 14 and/or CN 20 (FIG. 1) may set/specify and/or update the beam hopping schedule for satellite 12. If desired, different satellites may have different beam hopping schedules. If desired, multiple signal beams 64 may be active at the same time in the beam hopping scheme (e.g., where the transmit power of satellite 12 is divided between the active signal beams 64).

Each signal beam 64 of the phased array antenna may overlap a different respective area 66 on Earth. Areas 66 are sometimes also referred to herein as spot beams 66 or cells 66 of satellite 12 or the phased array antenna of satellite 12. Each spot beam 66 represents the projection, onto Earth’s surface, of a different respective signal beam 64 of the phased array antenna. The geographic locations on Earth that are overlapped by spot beams 66 change over time as satellite 12 moves in its orbit around Earth. If desired, each spot beam 66 formable by satellite 12 may at least partially overlap at least one other spot beam 66 formable by that satellite 12 to minimize coverage gaps. All of the active and inactive spot beams 66 of the phased array antenna may represent the overall coverage area of the phased array antenna and satellite 12 at a given time.

If desired, radios 60 and antenna(s) 62 may support communications using multiple polarizations. For example, radios 60 and antenna(s) 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). If desired, the set of signal beams 64 formable by satellite 12 may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams 64 having any desired polarizations. A satellite 12 may, for example, transmit (forward) one or more broadcast messages and/or one or more FWD datagrams and/or may receive one or more RWD datagrams using some or all of its signal beams during each system cycle of communications between UE devices 10 and CN 20. Different signal beams may, for example, be active during different respective subsets of each system cycle. In other implementations, multiple signal beams may be active during the same portion(s) of each system cycle.

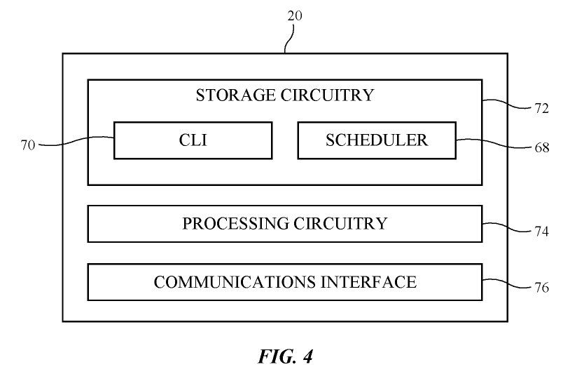

FIG. 4 is a schematic diagram of CN 20. The components of CN 20 may be implemented on one or more underlying physical devices in network portion 18 (FIG. 1). As shown in FIG. 4, CN 20 may include storage circuitry 72 (e.g., similar to storage circuitry 46 of FIG. 2) and processing circuitry 74 (e.g., similar to processing circuitry 48 of FIG. 2). CN 20 may also include one or more communications interfaces such as communications interface 76.

Storage circuitry 72 may store a communications scheduler such as scheduler 68 (e.g., a software-based scheduler that is executed using processing circuitry 74). Scheduler 68 may store communications schedules (e.g., FWD communications schedules) for each of the UE devices 10 that communicate with CN 20 (e.g., that communicate with CN 20 via constellation 32 of FIG. 1 while the UE devices are off-grid and/or that communicate with CN 20 via terrestrial-based communications equipment 22 while the UE devices are on-grid). Scheduler 68 may, for example, generate forward link traffic grants for the UE devices based on and/or implementing the stored communications schedules. Communications interface 76 may transmit FWD data (e.g., as received from another UE device, a CDN, or another data source, terminal, or end host in communications system 38) to UE devices 10 via constellation 32 and gateway(s) 14 (FIG. 1). Communications interface 76 may also receive RWD data from UE devices 10 via constellation 32. Communications interface 76 may forward the RWD data to a corresponding destination (e.g., another UE device, data destination, terminal, or end host in communications system 38). Communications interface 76 may include a wired communications interface (e.g., a cabled interface, an optical interface, etc.) and/or a wireless communications interface (e.g., wireless communications circuitry having one or more antennas).

Storage circuitry 72 may also store congestion level information (CLI) 70. Congestion level information 70 may identify a current congestion level (CL) for each satellite 12 in constellation 32. The congestion level of a given satellite 12 is a quantity that characterizes the amount of data traffic currently being handled by that satellite and/or the amount of data traffic congestion currently being experienced by that satellite (e.g., given that satellite’s bandwidth, power, beamforming capabilities, and/or other available communications resources). Congestion level may be characterized and stored on a per-satellite basis (e.g., where CLI 70 includes a current congestion level CL for each satellite 12) and/or may be characterized and stored on a per-beam basis (e.g., where CLI 70 includes a current congestion level for each signal beam of each satellite 12).

A satellite 12 (or a signal beam of the satellite) that is currently serving a relatively high number of UE devices generally exhibits a relatively high congestion level CL. On the other hand, a satellite 12 (or a signal beam of the satellite) that is currently serving no UE devices or a relatively low number of UE devices generally exhibits a relatively low congestion level CL. The magnitude of the congestion level may be identified, defined, or characterized by a corresponding congestion level indicator. The congestion level indicator may be, for example, a numeric value represented by a series of one or more bits. CN 20 may generate, refresh, and/or update CLI 70 during each system cycle of each satellite 12 (e.g., based on the amount of RWD data and/or FWD data and/or the number of UE devices served by each beam of the satellite during each system cycle). CN 20 may store a most recent congestion level for each satellite 12 (or for each beam of each satellite 12) in CLI 70 and may, if desired, store or retain earlier congestion levels for each satellite 12 (or for each beam of each satellite 12). If desired, scheduler 68 may schedule communications with UE devices 10 via satellites 12 based on the congestion levels identified by CLI 70 (e.g., using a load balancing scheme that helps to reduce the congestion level for satellites beams that exhibit a relatively high congestion level and/or that increases the congestion level for satellite beams that exhibit a relatively low congestion level in a manner that reduces latency for each of the served UE devices).

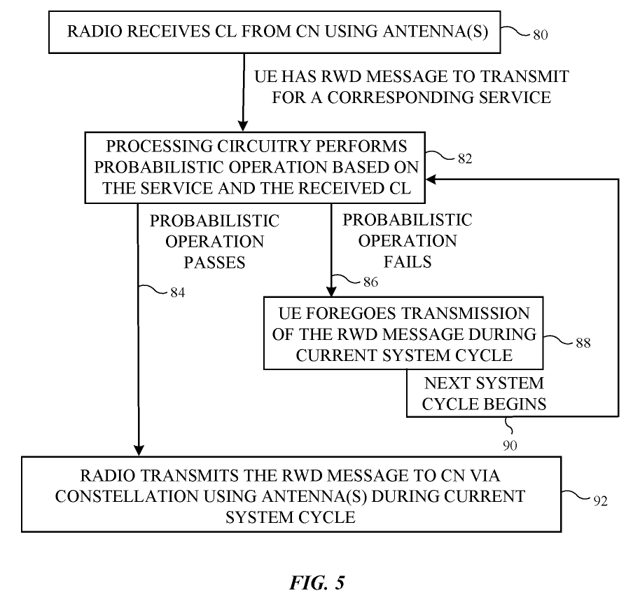

To help reduce load on the network while experiencing high levels of congestion, UE device 10 may utilize the current congestion level CL of its serving satellite 12 in scheduling and transmitting RWD signals to CN 20. FIG. 5 is a flow chart of illustrative operations that may be performed by UE device 10 in transmitting RWD signals (e.g., a RWD message) to CN 20. The operations of FIG. 5 may, for example, be performed by UE device 10 after connecting to (registering with) CN 20 for communications via constellation 32.

At operation 80, a radio 52 (FIG. 2) on UE device 10 receives a current congestion level CL of its serving satellite 12 from CN 20. CN 20 may maintain the current congestion level CL of the serving satellite 12 in its stored CLI 70 (FIG. 4). CN 20 may transmit the current congestion level CL within a broadcast message transmitted to all of the UE devices served by that satellite 12. UE device 10 may receive the broadcast message and may identify the current congestion level CL of its serving satellite 12 from the received broadcast message. Congestion level CL may represent a corresponding protocol congestion level and may be expressed by one or more bits in the broadcast message. As one example, congestion level CL may be represented by a four bit number (e.g., a congestion level indicator) that encodes one of sixteen possible congestion levels CL, from a value of zero corresponding to no congestion to a value of fifteen corresponding to maximum congestion. If desired, CN 20 may implement one or more policies associated with different sets of congestion levels. Each policy may identify what communications services are allowed by the CN under different congestion levels.

When UE device 10 has a RWD message to transmit to CN 20, processing may proceed to operation 82. The RWD message may, for example, be generated by a software application, a user input, and/or the operating system on UE device 10. The RWD message may be associated with a corresponding satellite communications-based service (e.g., a service implemented by the software application and/or operating system that utilizes the transmission and/or reception of wireless data via constellation 32). Services associated with the RWD message may include, for example, a text-based messaging service (e.g., a device-to-device messaging service), a device location service, a roadside assistance service, and/or an emergency messaging service (e.g., a device-to-emergency response service such as an SOS service). Different services may be associated with different communications priority levels.

Higher priority services may be prioritized for the limited communications resources of constellation 32 over lower priority services (e.g., to reduce data traffic congestion in constellation 32). For example, the emergency messaging service may be a high priority (HP) service, the roadside assistance and device location services may be medium priority (MP) services that are prioritized lower than HP services for satellite-based communications, and the text-based messaging service may be a low priority (LP) service that is prioritized lower than MP services for satellite-based communications. CN 20 may, if desired, implement different service policies for communications associated with HP services, MP services, and LP services.

At operation 82, processing circuitry 48 (FIG. 2) on UE device 10 may perform a probabilistic operation based on the service associated with the RWD message to be transmitted and based on the current congestion level CL received from its serving satellite 12. The probabilistic operation may be performed to determine whether to: (a) transmit the RWD message during the current system cycle, or (b) delay transmission of the RWD message to a later system cycle (e.g., foregoing transmission of the RWD message during the current system cycle). Delaying transmission of the RWD message may serve to reduce congestion during the current system cycle (e.g., helping other devices to successfully perform transmit and/or receive messages during the current system cycle) and may also serve to increase the probability that the CN will successfully receive the RWD message that is eventually transmitted by UE device 10 (e.g., by delaying transmission of the RWD message to a system cycle that exhibits less congestion than the current system cycle).

The probabilistic operation may, for example, involve a so-called weighted coin toss operation. The probabilistic (weighted coin toss) operation may be a binary operation having either a successful (passing) result or an unsuccessful (failing) result. The probability of a successful result may be inversely proportional to the current congestion level CL of the serving satellite 12 of UE device 10. A higher congestion level CL may be associated with a lower probability of a successful result of the probabilistic operation. A lower congestion level CL may be associated with a higher probability of a successful result of the probabilistic operation.

As one example, UE device 10 may perform the probabilistic operation by generating a random number between upper and lower bounds (e.g., between zero and 1.0 when normalized to 1.0). While referred to herein as a random number for the sake of simplicity, the random number may be a true random number or a pseudorandom number (e.g., generated using a random number or pseudorandom number generation algorithm). Once UE device 10 has generated the random number, UE device 10 may compare the random number to a predetermined range of numbers that is a continuous subset of the range spanned by the upper and lower bounds used for generating the random number. The predetermined range of numbers may be selected based on the current congestion level CL. For example, the predetermined range may be bounded by a threshold (e.g., a maximum upper threshold or a minimum lower threshold) that is selected based on the current congestion level CL.

Consider an example in which UE device 10 receives a broadcast message from its serving satellite 12 that contains a congestion level indicator identifying a congestion level CL equal to fourteen (e.g., where the congestion level indicator has a four-bit value of “1110” in implementations where the congestion level indicator is a four-bit value that identifies one of sixteen possible congestion levels). In this example, UE device 10 may compare its generated random number to a predetermined range of numbers that is bounded by a threshold value that is selected based on the congestion level (e.g., where the predetermined range is larger than when the congestion level is equal to fifteen but smaller than when the congestion level is less than fourteen). If/when the random number is within the predetermined range (e.g., less than a maximum threshold and/or greater than a minimum threshold bounding the predetermined range), UE device 10 determines that the probabilistic operation is successful (passes) and processing proceeds to operation 92 via path 84.

For example, UE device 10 may generate a random number between zero and 1.0 (or between any other upper and lower bounds). UE device 10 may compare the random number to a predetermined range of numbers bounded by a maximum threshold such as 0.10 (or some other value). In the example where the congestion level CL is equal to fourteen (in a four-bit implementation where a value of zero corresponds to a lowest congestion level and a value of fifteen corresponds to a highest congestion level of sixteen possible congestion levels), the threshold may be set relatively low (e.g., to 0.10), which reduces the probability that the random number will be within the predetermined range (e.g., between zero and 0.10). The threshold may be set even lower when congestion level CL is equal to fifteen. On the other hand, in situations where the congestion level CL is lower than fourteen, the maximum threshold may be set higher (e.g., to 0.20 or another value when the congestion level is equal to ten, to 0.40 or another value when the congestion level is equal to nine, to 0.50 or another value when the congestion level is equal to eight, etc.), effectively increasing the size of the predetermined range and increasing the probability that the random number will be less than the maximum threshold. In this way, UE device 10 may be more likely to delay transmission when its serving satellite 12 exhibits a higher congestion level than a lower congestion level. If desired, the particular thresholds defining the predetermined region may depend on the service associated with the RWD message to be transmitted. For example, the predetermined range may be smaller for services that are lower priority and may be larger for services that are higher priority (e.g., the probability of the probabilistic operation passing may be larger for a given congestion level CL when the service is a higher priority service than when the service is a lower priority service).

At operation 92 (e.g., in response to the probabilistic operation passing), radio 52 may use antenna(s) 54 to transmit the RWD message to CN 20 via the serving satellite 12 of UE device 10. On the other hand, if/when the random number is outside of the predetermined range (e.g., greater than a maximum threshold or less than a minimum threshold bounding the predetermined range), UE device 10 determines that the probabilistic operation is unsuccessful (fails) and processing proceeds from operation 82 to operation 88 via path 86.

At operation 88, radio 52 foregoes uplink transmission of the RWD message to the serving satellite 12 of UE device 10 during the current system cycle. Processing then loops back to operation 82 via path 90 and UE device 10 performs the probabilistic operation again to determine whether to transmit the RWD message during the next system cycle (e.g., based on the current congestion level CL of the serving satellite, which may change during the next system cycle as identified by the broadcast message transmitted during the next system cycle). Each UE device in the set of UE devices served by the same serving satellite 12 may execute the operations of FIG. 5 to perform its respective RWD message transmissions, which may effectively reduce the number of simultaneous RWD message transmissions to the serving satellite during a given system cycle (e.g., where RWD messages associated with higher priority services are more likely to be transmitted than RWD messages associated with lower priority services). This may help to prevent or mitigate congestion at satellite 12 in a manner that fairly allows access to CN 20 for all of the UE devices serviced by that satellite given their associated service priorities. This procedure of probabilistically performing RWD message transmission during each system cycle is sometimes also referred to as RWD transmission backoff (e.g., where the probability of RWD transmission backoff is defined by the probability of foregoing RWD message transmission during the current system cycle).

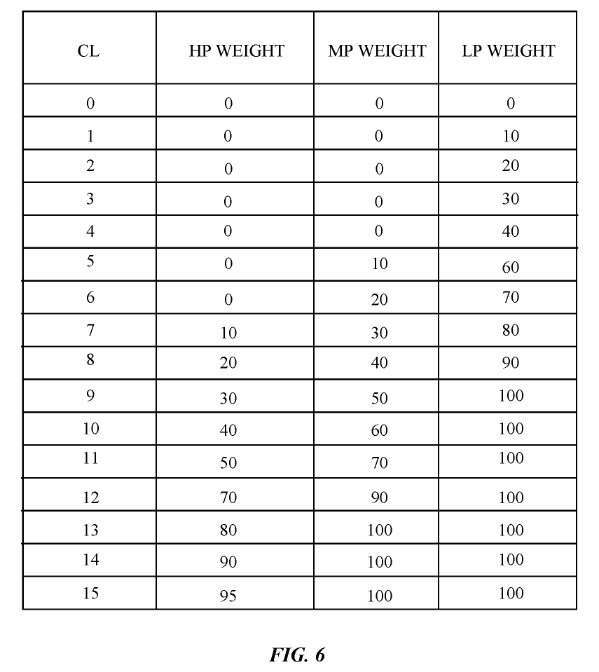

FIG. 6 is a table showing examples of different weight factors that may be applied by UE device 10 when performing the probabilistic operation to determine whether to transmit a RWD message for an associated service during a given system cycle (e.g., while processing operation 82 of FIG. 5). The first column of FIG. 6 lists different congestion levels CL of the serving satellite 12, in an example where the congestion level of the serving satellite is represented by a four-bit number encoding sixteen different possible congestion levels from zero to fifteen. The UE device may identify the particular congestion level CL to apply based on the received broadcast message for the current system cycle (e.g., at operation 80 of FIG. 5). The congestion levels CL shown in FIG. 6 are sometimes also referred to as protocol congestion levels CL.

The second column of FIG. 6 lists examples of weight values that may be utilized in the probabilistic operation for RWD message transmissions associated with a HP service under different congestion levels CL. The third column lists examples of weight values that may be utilized in the probabilistic operation for RWD message transmissions associated with a MP service under different congestion levels CL. The fourth column lists examples of weight values that may be utilized in the probabilistic operation for RWD message transmissions associated with a LP service under different congestion levels CL.

Each weight value shown in FIG. 6 represents the probability (in percent %) that the probabilistic operation utilizing that weight value will fail. As such, each weight value also corresponds to the predetermined range that the random number is compared to while processing operation 82 of FIG. 5 (e.g., where the random number is compared to a predetermined range from zero to an upper limit given by 100 minus the weight value shown in FIG. 6). A weight value of zero, for example, corresponds to a comparison of the random number to a predetermined range extending from 0 to 1.0 (e.g., indicating that the probabilistic operation is 0% likely to fail and thus 100% likely to succeed), a weight value of 100 corresponds to a comparison of the random number to a predetermined range extending from 0 to 0 (e.g., indicating that the probabilistic operation is 100% likely to fail and thus 0% likely to succeed), a weight value of 50 corresponds to a comparison of the random number to a predetermined range extending from 0 to 0.5 (e.g., indicating that the probabilistic operation is 100% likely to fail and thus 0% likely to succeed), a weight value of 70 corresponds to a comparison of the random number to a predetermined range extending from 0 to 0.7 (e.g., indicating that the probabilistic operation is 70% likely to fail and thus 30% likely to succeed), etc.

In the example of FIG. 6, when the congestion level CL for a given system cycle is zero, UE device 10 is 100% likely to succeed in performing the probabilistic operation and will always perform its RWD message transmission during that system cycle regardless of whether the RWD message is associated with an HP service, an MP service, or a LP service. As congestion level CL increases, the probability that the UE device will perform its RWD message transmission during the system cycle decreases more rapidly for RWD messages associated with LP services than for RWD messages associated with MP services and decreases more rapidly for RWD messages associated with MP services than for RWD messages associated with HP services. For example, when the congestion level CL for the system cycle is equal to one, UE device 10 is still 100% likely to succeed in performing the probabilistic operation and will always perform its RWD message transmission during that system cycle when the RWD message is associated with an HP or MP service but is only 90% likely to succeed in performing the probabilistic operation and is thus 90% likely to perform its RWD message transmission during that system cycle when the RWD message is associated with an LP service. As yet another example, when the congestion level CL for the system cycle is equal to nine, UE device 10 is 70% likely to succeed in performing the probabilistic operation and is thus 70% likely to perform its RWD message transmission during the system cycle when the RWD message is associated with an HP service, is 50% likely to succeed in performing the probabilistic operation and is thus 50% likely to perform its RWD message transmission during the system cycle when the RWD message is associated with an MP service, and is 0% likely to succeed in performing the probabilistic operation and is thus guaranteed to forego its RWD message transmission during the system cycle when the RWD message is associated with an LP service.

As can be seen from this trend, the UE device will forego RWD message transmission for the current system cycle (e.g., helping to alleviate congestion during the current system cycle and increasing the likelihood that the RWD message will be successfully received at the CN) for RWD messages associated with LP services under a sufficiently congested condition before foregoing transmission of RWD messages associated with MP or HP services. This may help to ensure that higher priority RWD messages (e.g., RWD messages associated with requesting help from emergency services) are successfully received by the CN as soon as possible even when the serving satellite is congested. The example of FIG. 6 is illustrative and non-limiting. UE device 10 may utilize any desired HP, MP, and LP weight values for different congestion levels CL. UE device 10 may utilize more than sixteen congestion levels or fewer than sixteen congestion levels if desired.

Different congestion levels CL or sets of congestion levels CL (e.g., protocol congestion levels) and the corresponding weight values (e.g., continuous sets of rows in the table of FIG. 6) may be associated with different user experience (UX) congestion levels. For example, the set of congestion levels CL from zero to eight (e.g., the second through tenth rows of the table in FIG. 6) may be associated with a first UX congestion level, the set of congestion levels CL from nine to twelve may be associated with a second UX congestion level higher than the first UX congestion level, the set of congestion levels CL from thirteen to fourteen may be associated with a third UX congestion level higher than the second UX congestion level, and the highest congestion level CL = 15 may be associated with a fourth UX congestion level higher than the third UX congestion level. If desired, CN 20 may apply different communications and registration policies for satellite communications based on the current UX congestion level of a serving satellite 12 and the particular service being used to perform RWD message transmission via that serving satellite 12.

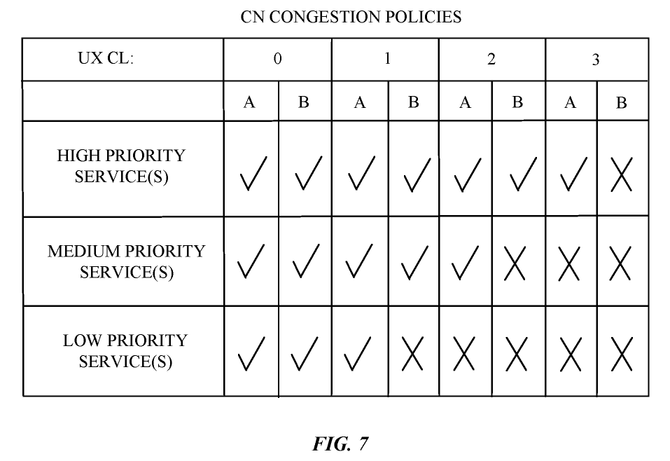

FIG. 7 is a table of exemplary congestion policies that may be implemented by CN 20 based on the current UX congestion level of a serving satellite 12 and the particular service being used to perform RWD message transmission via that serving satellite 12. The first row of FIG. 7 denotes four different UX congestion levels (e.g., a first UX congestion level of zero, a second UX congestion level of one, a third UX congestion level of two, and a fourth UX congestion level of three), each corresponding to a respective set of one or more protocol congestion levels (e.g., congestion levels CL in FIG. 6). Columns A of FIG. 7 indicate whether CN 20 will allow RWD messages to be conveyed for UE devices 10 via constellation 32 under different UX congestion levels when the RWD messages are associated with high priority service(s) (third row), medium priority service(s) (fourth row), and low priority service(s) (fifth row) running on the UE devices. Columns B of FIG. 7 indicate whether CN 20 will allow UE devices 10 to register with (connect to) CN 20 via constellation 32 under different UX congestion levels for communications by high priority service(s) (third row), medium priority service(s) (fourth row), and low priority service(s) (fifth row) running on the UE devices.

For example, as shown by the third row of FIG. 7, CN 20 may implement a congestion policy that allows UE devices to perform RWD message transmission for HP services under all four UX congestion levels and that allows new UE devices to register with CN for communications by HP services under the first three UX congestion levels but not the fourth UX congestion level. As shown by the fourth row of FIG. 7, CN 20 may implement a congestion policy that allows UE devices to perform RWD message transmission for MP services under the first three UX congestion levels but not the fourth UX congestion level and that allows new UE devices to register with CN for communications by MP services under the first two UX congestion levels but not the third and fourth UX congestion levels. As shown by the fifth row of FIG. 7, CN 20 may implement a congestion policy that allows UE devices to perform RWD message transmission for LP services under the first two UX congestion levels but not the third and fourth UX congestion levels and that allows new UE devices to register with CN for communications by LP services under the first UX congestion level but not the second, third, and fourth UX congestion levels. Implementing this type of policy may help to reduce overall congestion in constellation 32 while accounting for fairness in communication and increasing the likelihood that important messages such as emergency messages are successfully received by the CN (e.g., given the limited communications resources of satellites 12 in space). The example of FIG. 7 is illustrative and non-limiting and, in general, CN 20 may implement any desired policies for RWD communications and network registration.

In this way, CN 20 may implement a context-aware priority queue for satellite communications with different quality of service (QoS) levels. Within each transmission opportunity (system cycle), the CN may also prioritize FWD transmission queues based on their priority levels. The CN may transmit a FWD message from a specific priority queue if/when the higher priority queues are empty and the message is the earliest message from its priority queue. In practice, the FWD/RWD bandwidth of constellation 32 is asymmetric (e.g., there may be greater RWD bandwidth to CN 20 than there is FWD bandwidth to UE devices 10). Each RWD message transmitted to CN 20 may, in practice, correspond to at least one FWD message transmitted in response to each RWD message that needs to be queued for transmission to UE devices 10 (in addition to FWD messages that are transmitted to UE devices 10 but that are not in response to a RWD message). If care is not taken, this asymmetry can increase communications latency for UE devices 10 in communicating with CN 20 via constellation 32. Techniques for decoupling RWD and FWD bandwidths to mitigate these issues are described below.

In practice, when a UE device 10 registers with CN 20 for communications via constellation 32 (e.g., using an exchange or handshake of RWD and FWD registration messages and/or acknowledgment (ACK) messages conveyed via the constellation), the UE device enters a communications session during which the UE device remains registered (connected) to the CN for satcom services. The communications session may have a predetermined duration (period). In the absence of successful reception of FWD data from CN 20 or successful reception of an acknowledgement (ACK) to RWD data transmitted by UE device 10 during a particular communications session, the communications session automatically ends after the predetermined duration of the communications session has elapsed. The predetermined duration of the communications session may be, as examples, 10-30 minutes, 15 minutes, 10-20 minutes, 10-60 minutes, 5-120 minutes, 1 hour, two hours, or other durations (e.g., durations that include at least 2 heartbeat periods, at least 5 heartbeat periods, at least 10 heartbeat periods, at least 15 heartbeat periods, 10-20 heartbeat periods, 5-30 heartbeat periods, etc.). The CN may maintain a timer that begins at the beginning of the communications session and that ends after the predetermined duration. At the end of the predetermined duration (e.g., at or prior to the timer elapsing), the UE device may transmit a RWD signal to CN 20 via the constellation that instructs or triggers the CN to extend or renew the communications session. Transmission of a FWD message or reception of an ACK to a FWD message at CN 20 may also serve to extend or renew the communications session for a subsequent predetermined duration.

However, prior to the end of the predetermined duration of the communications session, the CN generally has no knowledge of whether the UE device is currently available for receiving FWD messages via constellation 32. For example, the UE device may have been powered off, may have disabled its satcom services, a messaging application running on the UE device may be closed, the UE device may be put to sleep, the UE device may leave a coverage area of the satellites of constellation 32, and/or other situations may occur in which the UE device is no longer able or configured to receive FWD messages from CN 20 prior to the end of the predetermined duration. If care is not taken, the CN has no knowledge that the UE device is no longer able or configured to receive FWD messages and may continue to transmit FWD messages to the UE device prior to the end of the established communications session. These FWD messages represent wasted FWD bandwidth of constellation 32 (because the UE device will not successfully receive the FWD messages in these situations) and are sometimes also referred to as orphan FWD messages. Orphan FWD messages can substantially contribute to the congestion level of constellation 32 without serving a useful communications purpose as the FWD messages are never received by the intended recipient UE device. In some situations, for example, orphan FWD messages can represent as much as 40% of the FWD message traffic conveyed by constellation 32. To help prevent the transmission of wasteful orphan FWD messages and to further decrease the congestion of constellation 32, UE device 10 may transmit periodic heartbeat signals to CN 20 via constellation 32 during an active communications session. The CN may have knowledge, from receipt of the periodic heartbeat signals, that a registered UE device is still actually available to receive FWD messages during its communication session and the CN may update its FWD message transmission schedule based on this information accordingly (e.g., in a manner that reduces or prevents the transmission of orphan FWD messages).

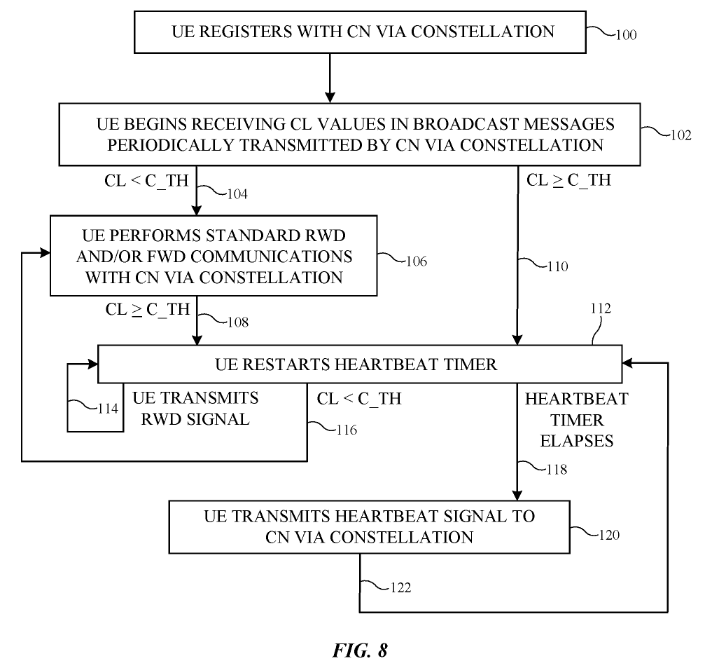

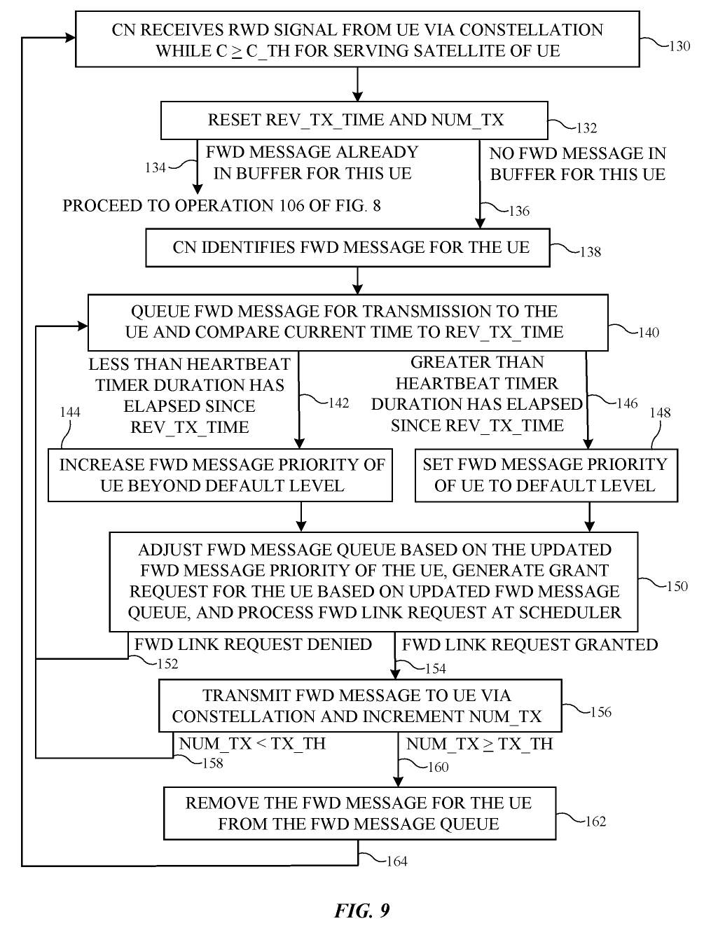

FIG. 8 is a flow chart of illustrative operations that may be performed by UE device 10 to transmit periodic heartbeat signals to CN 20 (e.g., for preventing congestion associated with the transmission of orphan FWD messages by CN 20). At operation 100, UE device 10 may register for satcom services via constellation 32. This may, for example, include the transmission of FWD and/or RWD registration messages and/or ACK messages between UE device 10 and CN 20 via constellation 32. Once UE device 10 has registered for satcom services, UE device 10 enters a corresponding communications (registration) session with CN 20 and is sometimes also referred to herein as being registered or connected to CN 20. The predetermined duration of the communications session begins upon registration.

At operation 102, UE device 10 may begin receiving broadcast messages from CN 20 via constellation 32 (e.g., during the BCI of each system cycle of constellation 32). The broadcast messages may include a congestion level indicator that identifies the current congestion level CL of the serving satellite 12 of UE device 10. UE device 10 may identify the current congestion level CL of its serving satellite 12 from the received broadcast message (e.g., operation 102 may be performed while processing operation 80 of FIG. 5). UE device 10 may continue to periodically receive broadcast messages from CN 20 during subsequent system cycles (e.g., while processing the remaining operations of FIG. 8). UE device 10 may have knowledge of any updates to the congestion level CL of its serving satellite from the received broadcast messages.

Processing circuitry 48 may compare the current congestion level CL of its serving satellite 12 to a corresponding congestion level threshold CL_TH (e.g., equal to one of the sixteen four-bit congestion levels CL in FIG. 6) to determine whether the current congestion level CL exceeds congestion level threshold CL_TH. The value of congestion level threshold CL_TH may, for example, be selected based on the priority level of the service running on UE device 10 (e.g., based on whether UE device 10 has RWD messages to transmit for a HP service, an MP service, or a LP service). As non-limiting examples, congestion level threshold CL_TH may be equal to nine, thirteen, or fifteen (e.g., protocol congestion levels marking the boundary or limit between different UX congestion levels). Congestion level threshold CL_TH is sometimes also referred to herein as threshold congestion level CL_TH or simply as threshold CL_TH.

If/when the current congestion level CL is less than congestion level threshold CL_TH, UE device 10 is sometimes referred to as being in a non-congestion state and processing may proceed to operation 106 via path 104. At operation 106 (e.g., responsive to UE device 10 being in the non-congestion state), UE device 10 and CN 20 may perform regular RWD and/or FWD communications via constellation 32 (e.g., without UE device 10 generating or transmitting periodic heartbeat signals). UE device 10 may, for example, perform the operations of FIG. 5 for each RWD message that is transmitted to CN 20.

If/when the current congestion level CL is greater than or equal to (e.g., exceeds) congestion level threshold CL_TH, UE device 10 is sometimes referred to as being in a congestion state and processing may proceed to operation 112. For example, if UE device 10 never entered the non-congestion state, processing may proceed from operation 102 to operation 112 via path 110 in response to its current congestion level CL being greater than or equal to congestion level threshold CL_TH. As another example, when UE device 10 is already operating in the non-congestion state (e.g., at operation 106), processing may proceed from operation 106 to operation 112 via path 108 in response to the current congestion level CL being greater than or equal to congestion level CL_TH.

At operation 112, processing circuitry 48 on UE device 10 may restart, reset, or (re)initialize a heartbeat timer associated with the periodic transmission of heartbeat signals by UE device 10. The heartbeat timer may have a corresponding heartbeat period HBP (e.g., the frequency of heartbeat signal transmission may be equal to the inverse of heartbeat period HBP). Heartbeat period HBP is substantially shorter than the predetermined duration of the communications session. Heartbeat period HBP may be, for example 60 seconds, 50-70 seconds, 30-90 seconds, 30-120 seconds, less than 2 minutes, less than 3 minutes, less than 5 minutes, 10-120 seconds, or other periods (e.g., containing multiple system cycles, 2-20 system cycles, 5-30 system cycles, at least 5 system cycles, at least 10 system cycles, at least 20 system cycles, at least 30 system cycles, etc.).

After the heartbeat timer (e.g., heartbeat period HBP) has elapsed since the heartbeat time was reset, processing may proceed from operation 112 to operation 120 via path 118. At operation 120 (e.g., once the heartbeat time has elapsed), UE device 10 may transmit a heartbeat signal to CN 20 via constellation 32 (e.g., as a RWD signal). The heartbeat signal (sometimes also referred to herein as a heartbeat message, heartbeat frame, or heartbeat packet) may be devoid of RWD data (e.g., a RWD data payload or RWD data in a data payload field) to minimize the bandwidth consumed by the heartbeat signal. The heartbeat signal may, for example, have a similar packet/frame structure as an ACK message but, unlike an ACK message, the heartbeat signal is not transmitted in response to receipt of a corresponding FWD message and does not reference or identify a previously transmitted FWD message. As other examples, the heartbeat signal may have the same or similar structure as a RWD message, a control signal or message, and/or any other desired signal waveform. If desired, the heartbeat signal may include identification information associated with UE device 10 such as a temporary user identifier (TUID) of UE device 10. In addition, unlike a standard RWD message transmitted by UE device 10 to CN 20, the heartbeat signal does not trigger the transmission of a corresponding ACK message by CN 20 upon receipt of the heartbeat signal (e.g., to conserve bandwidth, CN 20 may forego transmission of ACK messages indicating successful receipt of a heartbeat signal at CN 20). In this way, the heartbeat signals may effectively form a lightweight (low data/bandwidth) “send-and-forget” message transmitted to the CN at predetermined intervals (e.g., every heartbeat period HBP).

The TUID of UE device 10 is a number represented by a series of binary bits that is used to uniquely identify UE device 10 for wireless services at CN 20. The TUID may, for example, include a series of 20 bits, 10-30 bits, 10-50 bits, or any other desired number of bits. Longer TUIDs may reduce the risk of the same TUID incidentally being generated by multiple different UE devices in a given signal beam but also consume more resources to transmit via the bandwidth-limited satellite constellation. UE device 10 may also be identified by a permanent user identifier that is persistent across communications sessions (e.g., as configured by the network, upon manufacture, by software running on UE device 10, etc.). Unlike a permanent user identifier, the temporary user identifier may be used to identify UE device 10 for just a single communications session (e.g., while the UE device remains registered/connected to the CN) and is discarded after that communications session has ended. Different TUIDs may be produced and used for subsequent communications sessions.

The heartbeat signal may serve as an indication or identifier (e.g., proof of life) to CN 20 that UE device 10 is still actively connected to CN 20 and is still able to receive FWD link messages from CN 20 via constellation 32. If/when UE device 10 is unable to receive FWD link messages from CN 20 (e.g., due to power down, lack of coverage, closing of a messaging application on UE device 10, and/or any other trigger condition), UE device 10 will not transmit RWD messages or heartbeat signals to CN 20. CN 20 may use the presence or absence of RWD messages and heartbeat signals from UE device 10 to know whether or not UE device 10 is still connected, ready, and able to receive FWD messages from CN 20 prior to the end of a given communications session (e.g., prior to the predetermined duration of the communications session elapsing). After UE device 10 has transmitted a heartbeat signal, processing may loop back to operation 112 via path 122 and UE device 10 may once again reset its heartbeat timer.

If/when UE device 10 transmits a RWD signal or message prior to the heartbeat timer elapsing, processing may loop back to operation 112 via path 114 and UE device 10 may reset the heartbeat timer. Put differently, transmission of a RWD message (other than a heartbeat signal) may also serve to trigger a restart to the heartbeat timer. This is because the transmitted RWD signal or message may serve a similar purpose to a heartbeat signal in informing CN 20 that UE device 10 is still able to receive FWD messages prior to the end of the current communications session (e.g., in addition to conveying desired RWD data to the CN). If/when UE device 10 leaves the congested state (e.g., if/when the congestion level CL identified by a broadcast message received prior to the end of the heartbeat timer falls below congestion level threshold CL_TH), processing may loop back from operation 112 to operation 106 via path 116 and the UE and CN may perform regular FWD and/or RWD communications (e.g., without the transmission of heartbeat signals). In this way, CN 20 may have more up-to-date knowledge of the ability of UE device 10 to receive FWD messages prior to the end of the current communications session than when no heartbeat signaling is implemented. This may allow the CN to update its FWD message transmission scheduling in a manner that reduces the overall congestion of constellation 32 (e.g., reducing the transmission of orphan FWD messages) and/or that prioritizes FWD transmissions with UE devices that are still able to receive FWD messages over UE devices that have potentially left coverage of constellation 32 prior to the end of the associated communications session.

FIG. 9 is a flow chart of illustrative operations that may be performed by CN 20 to adjust FWD message transmission for a given UE device based on RWD signals received from that UE device 10 (e.g., in a manner that reduces the transmission of orphan FWD messages and thus helps to improve the congestion and the rate of successful communications via constellation 32). The operations of FIG. 9 may be performed after UE device 10 has registered with CN 20.

At operation 130, CN 20 may receive a RWD signal from UE device 10 via constellation 32 and a corresponding gateway 14 while the current congestion level CL of the serving satellite 12 for UE device 10 is greater than or equal to congestion level threshold CL_TH (e.g., during a system cycle containing a BCI transmission by CN 20 identifying the current congestion level CL exceeding congestion level threshold CL_TH). The RWD signal may be a RWD message (e.g., transmitted by UE device 10 while processing operation 106 or loop 114 of FIG. 8) or a heartbeat signal (e.g., transmitted by UE device 10 while processing operation 120 of FIG. 8) transmitted by UE device 10 during the active communication session for the UE device.

At operation 132, CN 20 may reset, restart, or re-initialize a reverse link transmission timer REV_TX_TIME and a FWD message transmission counter NUM_TX maintained at the CN for UE device 10. CN 20 may reset timer REV_TX_TIME by setting timer REV_TX_TIME equal to the current time (e.g., the time at which CN 20 received the RWD signal from UE device 10 at operation 130, or the time at which UE device 10 transmitted the RWD signal and as identified by a transmission timestamp included in the RWD signal). CN 20 may reset counter NUM_TX by setting counter NUM_TX equal to zero.

CN 20 may then perform a storage check on storage circuitry 72 of FIG. 4 to determine whether there is already a FWD message for UE device 10 stored in a transmission buffer of CN 20 (e.g., a MAC buffer of CN 20). If/when there is already a FWD message stored for UE device 10 in the MAC buffer, processing may proceed to operation 106 of FIG. 8, as shown by path 134, and CN 20 may forego the other operations of FIG. 9. If/when there are no FWD messages stored for UE device 10 in the MAC buffer, processing may proceed to operation 138 via path 136.

At operation 138, CN 20 may identify a FWD message for transmission to UE device 10. CN 20 may, for example, receive the FWD message from another terminal, host, node, or UE device of the terrestrial network, from another UE device via constellation 32, from a CDN, or from any other desired source. CN 20 may, for example, receive and identify the received FWD message at the application layer. In response to identifying the FWD message at the application layer, the application layer may send the FWD message to the MAC buffer for queuing.

At operation 140, CN 20 may queue the identified FWD message for transmission to UE device 10 (e.g., storing the identified FWD message in the MAC buffer). CN 20 may then identify the amount of time (duration) that has elapsed since timer REV_TX_TIME was reset at operation 132. This may include, for example, calculating, computing, or identifying the difference between the current time (e.g., at or after queuing of the FWD message in the MAC buffer) and the value of timer REV_TX_TIME (e.g., as set at operation 132). CN 20 may compare the difference between the current time and the value of timer REV_TX_TIME (e.g., the amount of time that has elapsed since timer REV_TX_TIME was reset) to heartbeat timer period HBP (sometimes also referred to herein as heartbeat timer duration HBP).

If/when an amount of time less than heartbeat timer period HBP has elapsed since timer REV_TX_TIME was reset (e.g., if/when the difference between the current time and the value of timer REV_TX_TIME as reset at operation 132 is less than the duration of heartbeat timer period HBP), this may be indicative of UE device 10 still being active and able to receive FWD messages during its current communications session, and processing may proceed to operation 144 via path 142. At operation 144 (e.g., responsive to the identified time difference being less than heartbeat timer period HBP), CN 20 may increase the FWD message priority for UE device 10 beyond a default priority level (e.g., elevating the FWD message priority for this UE device to a medium priority from a low priority or to a high priority from a low or medium priority). If desired, CN 20 may maintain the current FWD message priority for UE device 10 if the FWD message priority for UE device 10 is already sufficiently high (e.g., medium priority, high priority, etc.). Processing may then proceed to operation 150.

On the other hand, if/when an amount of time greater than or equal to heartbeat timer period HBP has elapsed since timer REV_TX_TIME was reset (e.g., if/when the difference between the current time and the value of timer REV_TX_TIME as reset at operation 132 being equal to or exceeding the duration of heartbeat timer period HBP), this may be indicative of UE device 10 no longer being active and able to receive FWD messages during its current communications session, and processing may proceed from operation 140 to operation 148 via path 146. At operation 148 (e.g., responsive to the identified time difference exceeding heartbeat timer period HBP), CN 20 may set the FWD message priority for UE device 10 to the default priority level (e.g., a priority less than the priority set while processing operation 144, effectively deprioritizing the FWD message). If desired, CN 20 may maintain the current FWD message priority for UE device 10 when the FWD message priority for UE device 10 is already sufficiently low (e.g., low priority or another default priority). Processing may then proceed to operation 150. In this way, CN 20 may prioritize subsequent FWD message scheduling and transmission to UE device 10 when the CN has knowledge (e.g., from the received RWD signal) that UE device 10 is still active and able to receive FWD messages during its current communication session (e.g., indicative of a low likelihood that a subsequent FWD message transmission to the UE device during its current communication session will be an orphan FWD message that wastes bandwidth of constellation 32). Conversely, CN 20 may deprioritize subsequent FWD message scheduling and transmission to UE device 10 when CN lacks knowledge that UE device 10 is still active and able to receive FWD messages during its current communication session (e.g., boosting the likelihood that other UE devices will be able to successfully receive FWD messages given the current congestion level of the serving satellite).

At operation 150, CN 20 may generate, update, and/or adjust its FWD message queue (e.g., MAC queue) for the serving satellite of UE device 10 based on the current FWD message priority of UE device 10 (e.g., as set or updated while processing operations 144 or 148). Scheduler 68 (FIG. 4) may generate a FWD grant request for UE device 10 in the current system cycle based on the updated FWD message queue and thus the current (updated) FWD message priority of UE device 10. Scheduler 68 (FIG. 4) may process the FWD grant request based on the current traffic load and resource consumption of constellation 32 to determine whether or not to grant the FWD grant request for the current system cycle. Scheduler 68 may, for example, deny the FWD grant request if/when the bandwidth of the serving satellite is full for the current system cycle. If/when scheduler 68 denies the FWD grant request, processing may loop back to operation 140 via path 152 and CN 20 may attempt to generate a FWD grant for UE device 10 to receive the FWD message during the next system cycle.

If/when scheduler 68 grants the FWD grant request, scheduler 68 may generate a corresponding FWD grant for UE device 10 to receive the FWD message via its serving satellite and processing may proceed to operation 156 via path 154. The FWD grant may, for example, specify an air (transmit) time and/or other communications resources that are used by a corresponding gateway 14 to transmit the FWD message to UE device 10 via its serving satellite 12. CN 20 may transmit the FWD grant to the corresponding gateway 14 to configure the gateway to transmit the FWD message according to the FWD grant. At operation 156, gateway 14 may transmit the FWD message to UE device 10 via at least its serving satellite 12 of constellation 32, according to the generated FWD grant. Upon transmission of the FWD message and/or the FWD grant by CN 20, CN 20 may increment the integer value of counter NUM_TX (e.g., counter NUM_TX may identify the number of transmission attempts of the FWD message since the counter was last reset to zero).

CN 20 may compare the current (incremented) value of counter NUM_TX to a transmission counter threshold TX_TH. Transmission counter threshold TX_TH may set or characterize the number of times CN 20 will attempt to transmit a particular FWD message to UE device 10 before removing the FWD message from the FWD message queue. While processing any of the operations of FIG. 9, processing may revert or loop back to operation 130 any time CN 20 receives a RWD signal from UE device 10 while UE device 10 is in the congestion state. For example, if UE device 10 receives an ACK message to the FWD message transmitted at operation 156, this may be indicative of UE device 10 having successfully received the transmitted FWD message and processing may return to operation 130 regardless of the number of times CN 20 has attempted to transmit the FWD message to UE device 10 from its FWD message queue. Transmission counter threshold TX_TH may be set sufficiently high to allow for a sufficient likelihood that UE device 10 will receive the queued and transmitted FWD message but may also be set sufficiently low to minimize the congestion associated with re-transmitting the FWD message. Transmission counter threshold TX_TH may be, for example, equal to seven, six, eight, five, four, nine, ten, three, 1-10, 5-10, 2-15, 3-20, or another integer value.

If/when the incremented value of counter NUM_TX is less than transmission counter threshold TX_TH, processing may loop back to operation 140 via path 158 and CN 20 may continue to attempt re-transmission of the FWD message during subsequent system cycles (e.g., subject to any updated priority as processed at operations 144 or 148). If/when the incremented value of counter NUM_TX is greater than or equal to transmission counter threshold TX_TH, this may be indicative of UE device 10 being unable to receive the transmitted FWD message (e.g., due to UE device 10 moving out of coverage or powering down since the last RWD signal transmission) and processing may proceed from operation 156 to operation 162 via path 160. At operation 162 (e.g., responsive to counter NUM_TX exceeding or equaling transmission counter threshold TX_TH), CN 20 may remove the FWD message from the FWD message (e.g., MAC) queue. This may configure CN 20 to stop attempting retransmission of the FWD message to UE device 10, helping to reduce congestion and increase the bandwidth available for other UE devices served by the same serving satellite 12. If desired, CN 20 may continue to store the FWD message in storage (e.g., storage other than the MAC queue) for transmission to UE device 10 after UE device 10 has returned on-grid or during a subsequent communications session.

Processing may loop back to operation 130 via path 164 and the operations of FIG. 9 may be performed the next time a RWD signal is received from UE device 10 during the current communications session. Once the predetermined period of the communications session has elapsed without receipt of a RWD signal or ACK signal from UE device 10, CN 20 may automatically end the communications session and may stop attempting to communicate with UE device 10 via constellation 32 until the UE device re-registers with CN 20 (e.g., during a subsequent instance of operation 100 of FIG. 8). Processing the operations of FIG. 9 may allow the CN to reduce congestion for UE device 10 and the other UE devices served by the same satellite 12, which may also help to increase the probability that any of the UE devices will be able to successfully communicate with CN 20, may decrease latency, etc. These operations may also introduce an element of fairness to FWD message scheduling between UE devices, allowing active and available UE devices without regular RWD message transmissions to participate in FWD message prioritization through the periodic transmission of low bandwidth heartbeat signals. In addition, these operations may effectively decouple the FWD and RWD bandwidths of the system, may serve to reduce the number of unnecessary FWD message re-transmissions, and may free up bandwidth in the forward link for active and available UE devices.

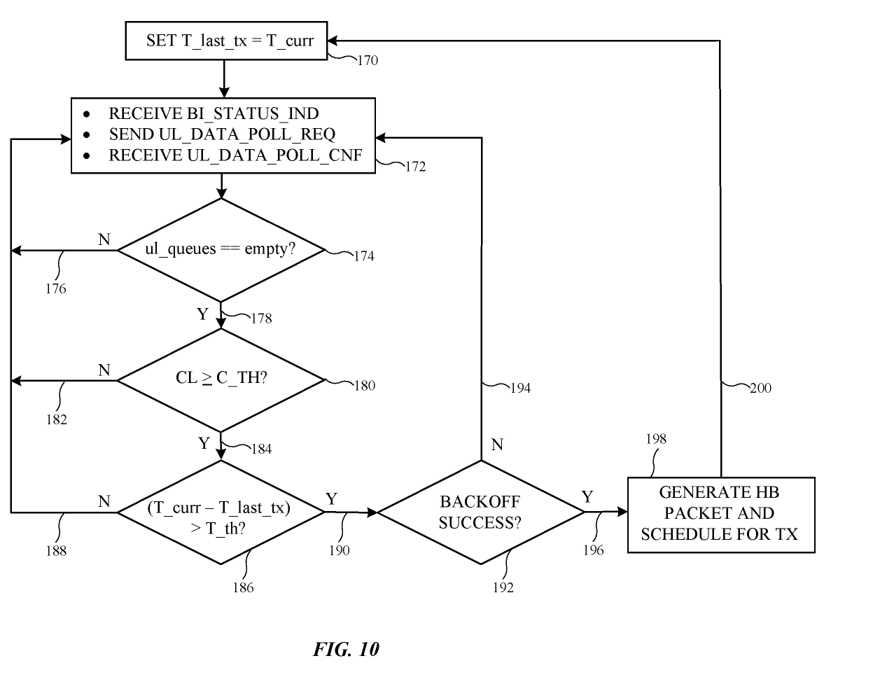

FIG. 10 is a flow chart of illustrative operations that may be performed by processing circuitry 48 of UE device 10 (e.g., at the MAC layer) to generate and transmit heartbeat signals to CN 20 (e.g., configuring CN 20 to reduce the consumption of bandwidth by orphan FWD messages). The operations of FIG. 10 may, for example, be performed by UE device 10 while processing some or all of the operations of FIG. 8.

At operation 170, UE device 10 may restart its own heartbeat timer (see, e.g., operation 112 of FIG. 8) by setting a timer T_last_tx equal to a current time T_curr.

At operation 172, the MAC layer of processing circuitry 48 may receive a broadcast interval status indicator BI_STATUS_IND (e.g., from the PHY layer), may send an UL data poll request UL_DATA_POLL_REQ to the LLC layer, and may receive a corresponding UL data poll confirmation signal UL_DATA_POLL_CNF from the LLC layer. Broadcast interval status indicator BI_STATUS_IND may, for example, identify the current congestion level CL of the serving satellite 12 for UE device 10. UL data poll request UL_DATA_POLL_REQ may, for example, serve as a check of whether the UL (RWD) message queue of UE device 10 is empty. UL data poll confirmation signal UL_DATA_POLL_CNF may, for example, serve as a confirmation of whether the UL (RWD) message queue of UE device 10 is empty (e.g., as polled by the corresponding UL data poll request UL_DATA_POLL_REQ).

At operation 174, processing circuitry 48 may determine whether the UL (RWD) message queue of UE device 10 is empty (e.g., based on UL data poll confirmation signal UL_DATA_POLL_CNF). The UL message queue may be stored at radio 52 and/or processing circuitry 48 (e.g., in corresponding storage circuitry, a buffer, a register, memory, etc.). The UL message queue being empty is indicative that there are no RWD messages already queued for transmission to CN 20. If/when the UL message queue is not empty, processing may loop back to operation 172 via path 176 (e.g., foregoing heartbeat signal generation in favor of RWD message transmission as shown by arrow 114 of FIG. 8). If/when the UL message queue is empty, processing may proceed to operation 180 via path 178.

At operation 180, processing circuitry 48 may determine whether the current congestion level CL of the serving satellite 12 for UE device 10 is greater than or equal to congestion level threshold C_TH (e.g., based on broadcast interval status indicator BI_STATUS_IND). If/when the current congestion level CL is not greater than or equal to congestion level threshold C_TH (e.g., is less than congestion level threshold C_TH), processing may loop back to operation 172 via path 182 to perform regular communications in the non-congested state (e.g., foregoing heartbeat signal generation, as shown by arrow 116 of FIG. 8). If/when the current congestion level is greater than or equal to congestion level threshold C_TH, processing may proceed to operation 186 via path 184.

At operation 186, processing circuitry 48 may determine whether the amount of time since timer T_last_tx was set (at the last iteration of operation 170) exceeds threshold time period T_th (e.g., processing circuitry 48 may determine whether the new current time T_curr minus the set T_last_tx is greater than T_th). Threshold time period T_th may be equal to the duration of heartbeat period HBP. If/when T_last_tx is not greater than threshold time period T_th (e.g., T_curr – T_last_tx < T_th or, equivalently, the heartbeat timer or the duration of heartbeat period HBP has not yet elapsed since timer T_last_tx was last set), processing may loop back to operation 172 via path 188. If/when T_last_tx exceeds threshold time period T_th (e.g., T_curr – T_last_tx > T_th or, equivalently, the heartbeat timer or the duration of heartbeat period HBP has elapsed since timer T_last_tx was last set), processing may proceed to operation 192 via path 190.

At operation 192, processing circuitry 48 may perform a probabilistic operation associated with RWD transmission backoff (e.g., the weighted coin toss in operation 82 of FIG. 5) and may determine whether the probabilistic operation was successful. If/when the probabilistic operation is not successful (fails), processing may loop back to operation 172 via path 194. If/when the probabilistic operation is successful (passes), processing may proceed to operation 198 via path 196.

At operation 198, processing circuitry 48 may generate a heartbeat signal (e.g., a heartbeat (HB) packet). Processing circuitry 48 may schedule the heartbeat signal for transmission and may transmit the heartbeat signal to CN 20 via constellation 32 (e.g., while processing operation 120 of FIG. 8). Processing may then loop back to operation 170 to reset timer T_last_tx (e.g., because the transmission of a heartbeat signal corresponds to a most-recent RWD signal transmission by UE device 10 that triggers reset of timer T_last_tx of FIG. 10 and the heartbeat timer at operation 112 of FIG. 8). Looping back to operation 170 of FIG. 10 via path 200 may, for example, correspond to path 122 of FIG. 8.

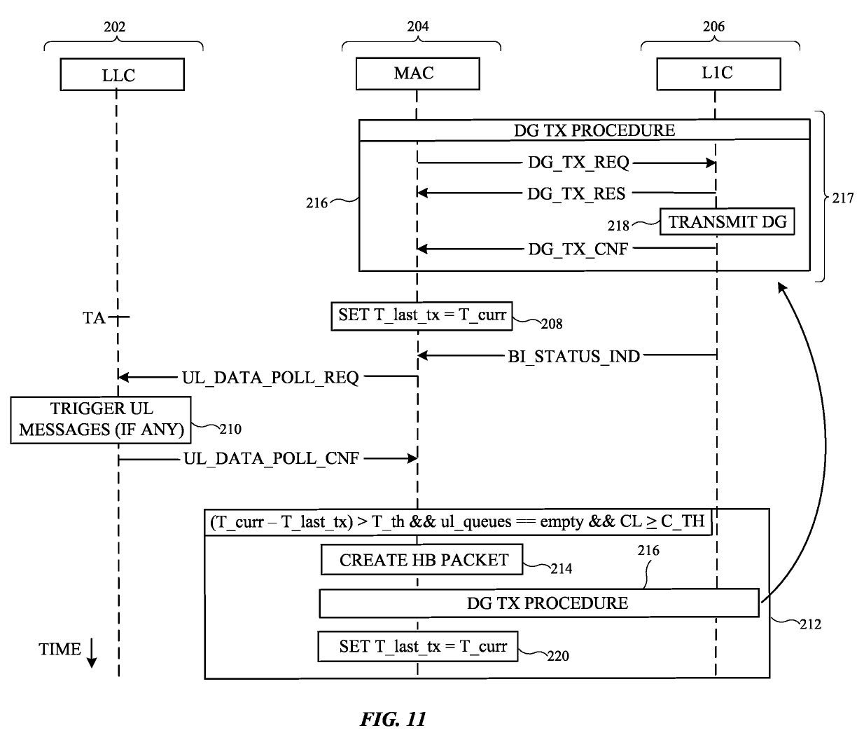

FIG. 11 is a timing diagram showing how different layers of processing circuitry 48 on UE device 10 may interact with each other to generate and transmit a heartbeat signal (e.g., while processing the operations of FIG. 10). Time is plotted along the vertical axis of FIG. 11. Portion 202 of FIG. 11 represents operations performed at the LLC layer by processing circuitry 48. Portion 204 of FIG. 11 represents operations performed at the MAC layer by processing circuitry 48 (e.g., while processing the operations of FIG. 10). Portion 206 represents operations performed at the L1C (e.g., PHY) layer by processing circuitry 48 and/or radio 52 on UE device 10.

As shown by operation 208 of FIG. 11, the MAC layer may set timer T_last_tx = T_curr at time TA (e.g., may perform operation 170 of FIG. 10 to set T_last_tx = T_curr = TA). The L1C layer may then send broadcast interval status indicator BI_STATUS_IND to the MAC layer (e.g., identifying the current congestion level CL of the serving satellite 12 of UE device 10). The MAC layer may then send UL data poll request UL_DATA_POLL_REQ to the LLC layer (e.g., to check whether the UL message queue for UE device 10 is empty). At operation 210, the LLC layer may trigger any UL (e.g., RWD) messages that need to be transmitted (if any). The LLC layer may then send a corresponding UL data poll confirmation signal UL_DATA_POLL_CNF to the MAC layer (e.g., confirming to the MAC layer whether there are any queued RWD messages for transmission). These operations may, for example, be performed while processing operation 172 of FIG. 10.

If/when T_curr – T_last_tx > T_th, the UL message queue is empty, and the current congestion level CL > C_TH, the MAC layer and the L1C layer may perform operation 212 (e.g., while processing operation 198 of FIG. 10). This may include, for example, the creation of a heartbeat signal (packet) at the MAC layer (operation 214), a datagram (DG) transmission (TX) procedure at operation 216, and a resetting of timer T_last_tx at operation 220 (e.g., corresponding to the loop back to operation 170 via path 200 of FIG. 10).

The DG TX procedure may involve the transmission of one or more datagrams that collectively represent or form the heartbeat signal (packet). Portion 217 of FIG. 11 illustrates one example of DG TX procedure 216. As shown in portion 217 of FIG. 11, the DG TX procedure may include the transmission of datagram transmit request DG_TX_REQ from the MAC layer to the L1C layer, the corresponding transmission of a datagram transmit response DG_TX_RES from the L1C layer to the MAC layer (e.g., informing the MAC layer that the L1C layer has accepted the datagram transmit request), the transmission of one or more datagrams representing the heartbeat signal at operation 218 (e.g., via antenna(s)54 of FIG. 2), and the transmission of a datagram transmission confirmation DG_TX_CNF from the L1C layer to the MAC layer (e.g., informing the MAC layer that the DG(s) have been transmitted). This example is illustrative and non-limiting and, if desired, UE device 10 may use other heartbeat signal transmission procedures.

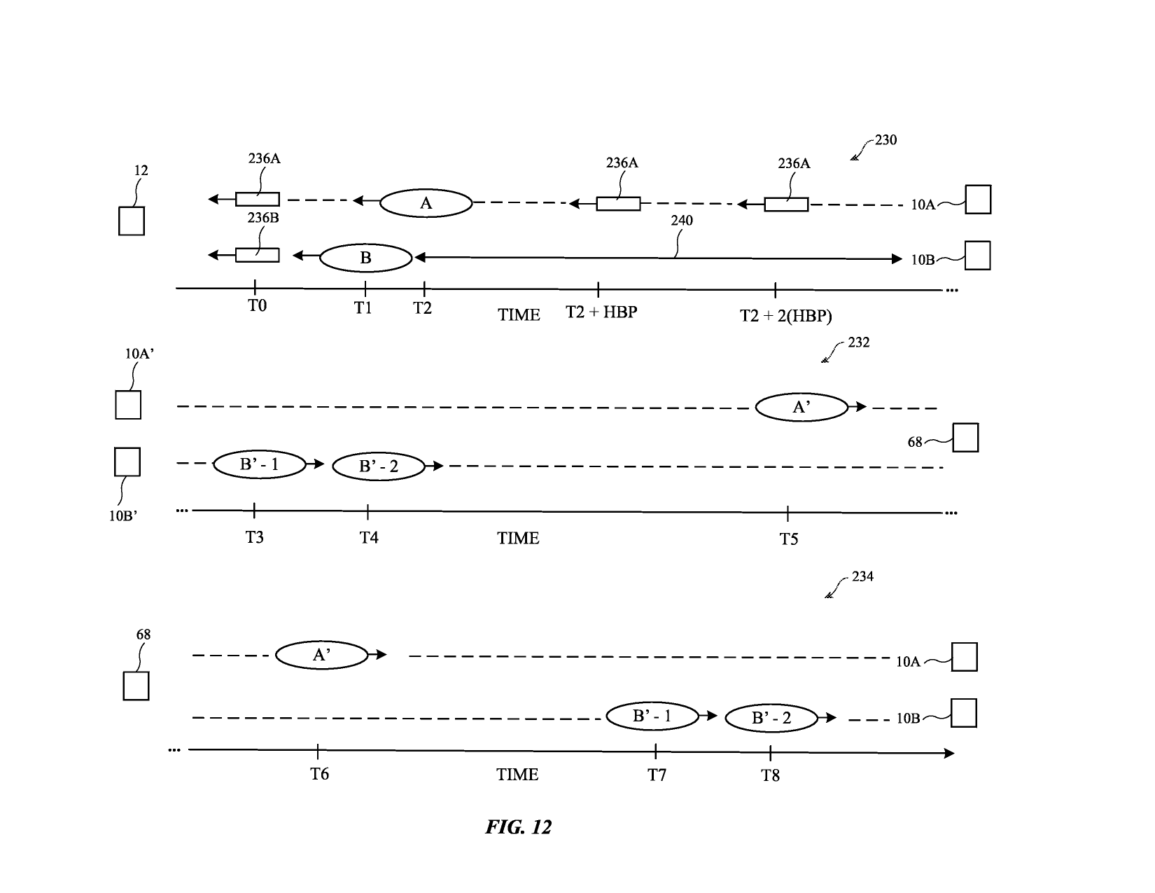

FIG. 12 is a timing diagram illustrating how CN 20 may utilize the periodic transmission of heartbeat signals by a first UE device 10A to prioritize FWD message transmissions to that UE device 10A (e.g., without the unnecessary transmission of orphan FWD messages, helping to alleviate congestion). The transmissions shown in FIG. 12 may be performed while UE device 10A is in a congested state and while processing the operations of FIGS. 8-11.

Portion 230 of FIG. 12 illustrates RWD transmissions from UE device 10A and another UE device 10B over time (e.g., prior to time T3). UE devices 10A and 10B are both off-grid devices that are registered to communicate with CN 20 via an associated serving satellite 12 of constellation 32 (e.g., via a same signal beam or cell of the serving satellite or via different signal beams of the serving satellite). UE device 10A utilizes the constellation and CN 20 to communicate with an on-grid UE device 10A’ during a corresponding first communications session that begins prior to time T0 but that has not yet ended (e.g., the predetermined time period of the first communications session does not elapse until after at least time T8 of FIG. 12). UE device 10B utilizes the constellation and CN 20 to communicate with an on-grid UE device 10B’ during a corresponding second communications session that begins prior to time T0 but that has not yet ended.

As shown in portion 230 of FIG. 12, UE device 10A transmits a heartbeat signal 236A to CN 20 via the serving satellite 12 at time T0 (e.g., due to the absence of RWD signal transmissions by UE device 10A for at least a heartbeat period HBP prior to time T0). UE device 10B also transmits a heartbeat signal 236B to CN 20 via the serving satellite 12 at time T0 (e.g., due to the absence of RWD signal transmissions by UE device 10B for at least a heartbeat period HBP prior to time T0).

UE device 10B transmits a RWD message B destined for UE device 10B’ at time T1. UE device 10A transmits a RWD message A destined for UE device 10A’ at time T2. After time T1, UE device 10B is no longer active and able to receive FWD signals from CN 20. This may be due to UE device 10B going on grid (e.g., connecting to a cellular or Wi-Fi network), leaving the corresponding satellite communications session, leaving the coverage area of all satellites 12 in constellation 12, powering off, closing a messaging software application, receiving a corresponding user input, etc. As such, UE device 10B does not transmit further heartbeat signals after time T1. On the other hand, UE device 10A remains active and able to receive FWD signals from CN 20 after time T2. As such, UE device 10B continues to periodically transmit heartbeat signals 236A after each heartbeat period HBP has elapsed since the transmission of RWD message A (e.g., at time T2 + HBP, then again at time T2 + 2*HBP, etc.). The serving satellite 12 may forward RWD messages A and B and heartbeat signals 236A and 236B to CN 20. CN 20 does not forward the heartbeat signals but may forward RWD message A to UE device 10A’ and may forward RWD message B to UE device 10B’.

CN 20 may utilize the heartbeat signals received from UE device 10A to update its FWD signal transmission scheduling, based on the knowledge that UE device 10A is still active and able to receive FWD signals as indicated by it continued transmission of heartbeat signals 236A (e.g., each heartbeat signal 236A may form the RWD signal received by CN 20 while processing operation 130 of FIG. 9). On the other hand, the absence of receipt of RWD messages and heartbeat signals 236B from UE device 10B (e.g., for at least time period 240 after receipt of message B) may cause CN 20 to continue to transmit orphan FWD messages to UE device 10B and/or may cause CN 20 to deprioritize FWD message transmission to UE device 10B during the remainder of its communications session.

Portion 232 of FIG. 12 illustrates FWD transmissions by UE devices 10A’ and 10B’ to the scheduler 68 of CN 20 (e.g., after time T2 + 2*HBP and prior to time T6). As shown in portion 232 of FIG. 12, UE device 10B’ transmits a set of FWD messages B’ in response to receiving RWD message B from UE device 10B, such as at least a FWD message B’-1 at time T3 and a FWD message B’-2 at time T4. CN 20 may receive FWD messages B’-1 and B’-2 and scheduler 68 may queue the FWD messages for subsequent transmission to UE device 10B via the constellation (e.g., while processing operation 140 of FIG. 9 for UE device 10B). Because CN 20 has not received RWD messages or heartbeat signals from UE device 10B for the duration of time period 240 (e.g., exceeding the duration of heartbeat period HBP), CN 20 may reduce the priority of FWD messages B’-1 and B’-2 and/or may set the priority of FWD messages B’-1 and B’-2 to a default priority in its FWD message queue for the serving satellite 12 (e.g., while processing operation 148 of FIG. 9 for UE device 10B).

In addition, UE device 10A’ transmits a FWD message A’ at time T5 in response to receiving RWD message A from UE device 10A (e.g., time T5 may be after time T4 because UE device 10A transmitted RWD message A after UE device 10B transmitted RWD message B and, as such, UE device 10A’ receives RWD message A after UE device 10B’ receives RWD message B). RWD messages A and B may be associated with services of the same priority level and FWD messages A’ and B’ may have the same priority level prior to receipt at the CN, for example. CN 20 may receive FWD message A after time T5 (e.g., while processing operation 138 of FIG. 9 for UE device 10A). Because CN 20 continued to received periodic heartbeat signals 236A from UE device 10A after transmission of RWD message A, CN 20 has knowledge that UE device 10A remains active and able to receive FWD messages. CN 20 may queue FWD message A for transmission to UE device 10A (e.g., while processing operation 140 of FIG. 9 for UE device 10A) and may increase the priority of FWD message A’ in its FWD message queue for the serving satellite 12 (e.g., while processing operation 144 of FIG. 9 for UE device 10B). This may effectively prioritize the transmission of FWD message A’ to UE device 10A higher than (ahead of) the transmission of FWD messages B’-1 and B’-2 to UE device 10B via the serving satellite.

Portion 234 of FIG. 12 illustrates FWD transmissions by CN 20 (e.g., as scheduled using scheduler 68) to UE devices 10A and 10B (e.g., after time T5). As shown in portion 234 of FIG. 12, CN 20 transmits FWD message A’ to UE device 10A at time T6. CN 20 then transmits FWD message B’-1 to UE device 10B at time T7 and transmits FWD message B’-2 to UE device 10B at time T8 (e.g., times later than time T6, during the same system cycle or during a later system cycle than the transmission of FWD message A’ to UE device 10A). This illustrates how CN 20 may prioritize transmission of FWD message A’ to UE device 10A (which continued to transmit periodic heartbeat signals after transmitting RWD message A) over transmission of FWD messages B’-1 and B’-2, which may form orphan FWD messages given that CN 20 did not receive heartbeat signals from UE device 10B during time period 240. This may help to ensure that UE device 10A receives its FWD message(s) with as little latency as possible given the current congestion level of the serving satellite, helping to improve user experience in performing communications using UE device 10A (as well as the other UE devices served by satellite 12) in a manner that fairly balances the congested communications resources of the system between UE device 10A, UE device 10B, and any other UE devices served by satellite 12 and/or constellation 32. The example of FIG. 12 is illustrative and non-limiting.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-12 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, network portion 18, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, network portion 18, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method comprising:
entering, using a radio, a communications session by registering with a core network via a satellite constellation;
receiving, using the radio during the communications session, a congestion level of the satellite constellation; and
periodically transmitting, using the radio during the communications session, heartbeat signals to the core network via the satellite constellation while the congestion level exceeds a threshold and while a reverse link message queue of the radio is empty.

2. The method of claim 1, wherein the heartbeat signals are configured to signal, to the core network, that a user equipment (UE) device is able to receive forward link messages from the core network via the satellite constellation prior to an end of a predetermined duration of the communications session.

3. The method of claim 1, wherein the communications session has a predetermined duration and the heartbeat signals are transmitted with a period that is shorter than the predetermined duration.

4. The method of claim 3, wherein predetermined duration is between 10 minutes and 60 minutes and the period is between 30 seconds and 120 seconds.

5. The method of claim 1, wherein the heartbeat signals comprise a temporary user identifier (TUID) of the UE device that is valid for a duration of the communications session.

6. The method of claim 5, wherein the heartbeat signals do not trigger transmission of an acknowledgment (ACK) packet from the core network.

7. The method of claim 5, wherein the heartbeat signals do not acknowledge receipt of a forward link message from the core network.

8. The method of claim 1, wherein:
receiving the congestion level comprises receiving broadcast messages from the core network via the satellite constellation during the communications session, and
the broadcast messages comprise a congestion level indicator identifying the congestion level.

9. The method of claim 8, wherein:
the congestion level indicator comprises a four-bit number representing one of a plurality of congestion levels, and
the congestion level threshold comprises one of the plurality of congestion levels.

10. The method of claim 1, further comprising:
transmitting, using the radio during the communications session, reverse link messages to the core network via the satellite constellation while the congestion level is less than the threshold;
beginning, using processing circuitry in response to the congestion level exceeding the threshold, a timer at a transmission time of a last of the reverse link messages;
transmitting a first of the heartbeat signals after a period has elapsed since the timer was begun;
resetting, using the processing circuitry, the timer at a transmission time of the first of the heartbeat signals; and
transmitting a second of the heartbeat signals after the period has elapsed since the timer was reset.

11. A method comprising:
receiving, from a first user equipment (UE) device via a serving satellite of a constellation in a first communications session, a first reverse link (RWD) message at a first time;
receiving, from a second UE device via the serving satellite in a second communications session, a second RWD message at a second time after the first time;
receiving, from the second UE device via the serving satellite in the second communications session, a series of periodic heartbeat signals after the second time, wherein the core network does not receive signals from the first UE device between the second time and an end of the first communications session;
receiving, from a first terminal at a third time after the second time and during the first communications session, a first forward link (FWD) message destined for the first UE device;
receiving, from a second terminal at a fourth time after the third time and during the second communications session, a second FWD message destined for the second UE device; and
transmitting, in the first communications session, the second FWD message to the second UE device via the serving satellite prior to transmitting the first FWD message to the first UE device.

12. The method of claim 11, wherein:
the first RWD message is transmitted for a first service running on the first UE device,
the second RWD message is transmitted for a second service running on the second UE device,
the first and second services have a same priority level, and
the first and second FWD messages have the same priority level prior to receipt at the core network.

13. The method of claim 11 wherein:
the first communication session begins before the first time and ends after the fourth time,
the first and second communications sessions have a same predetermined duration of at least 10 minutes, and
the series of periodic heartbeat signals has a period of less than 2 minutes.

14. The method of claim 11, wherein receiving the series of periodic heartbeat signals comprises receiving the series of periodic heartbeat signals while a congestion level of the serving satellite exceeds a threshold level.

15. The method of claim 11, wherein the series of periodic heartbeat signals comprises:
a first heartbeat signal received after a heartbeat period has elapsed since receipt of the second RWD message; and
a second heartbeat signal received after the heartbeat period has elapsed since receipt of the first heartbeat signal, wherein the core network does not receive any RWD signals other than the first heartbeat signal between receipt of the second RWD message and receipt of the second heartbeat signal.

16. The method of claim 15, wherein:
the first heartbeat signal comprises a temporary user identifier (TUID) of the second UE device,
the second heartbeat signal comprises the TUID of the second UE device,
the core network transmits, to the second UE device via the serving satellite, an acknowledgment (ACK) to receipt of the second RWD message, and
the core network does not transmit any ACKs to receipt of the first and second heartbeat signals.

17. A method comprising:
receiving, from a user equipment (UE) device via a satellite of a constellation, a reverse link (RWD) signal while a congestion level of the satellite exceeds a threshold;
resetting, using processing circuitry, a timer in response to receipt of the RWD signal;
receiving a forward link (FWD) message for the UE device and storing the FWD message in a transmission queue;
increasing, using the processing circuitry, a priority of the FWD message in the transmission queue in response to the FWD message being received less than a predetermined time period since the timer was reset; and
attempting to transmit the FWD message to the UE device via the satellite according to the transmission queue.

18. The method of claim 17, further comprising:
decreasing or maintaining, using the processing circuitry, the priority of the FWD message in the transmission queue in response to the FWD message being received after the predetermined time period has elapsed since the timer was reset.

19. The method of claim 18, wherein the RWD signal comprises a heartbeat signal that does not include a data payload and wherein a period of the heartbeat signal is equal to the predetermined time period.

20. The method of claim 17, wherein attempting to transmit the FWD message comprises attempting to transmit the FWD message during a first system cycle of the satellite, the method further comprising:
resetting, using processing circuitry, a counter in response to receipt of the RWD signal;
re-attempting, while the counter is less than a counter threshold, transmission of the FWD message to the UE device via the satellite during at least a second system cycle;
incrementing, using the processing circuitry, the counter upon each attempt to transmit the FWD message; and
removing, using the processing circuitry, the FWD message from the transmission queue when the counter exceeds the counter threshold.
